(19) United States
(12) Patent Application Publication
(10) Pub. No.: US 2007/0257766 A1
(43) Pub. Date: Nov. 8, 2007

(54) Micro-Transducer and Thermal Switch for Same

(76) Inventors: Robert F. Richards, Pullman, WA (US); David F. Bahr, Pullman, WA (US); Cecilia Richards, Pullman, WA (US)

Correspondence Address: DAVIS WRIGHT TREMAINE, LLP, 1201 Third Avenue, Suite 2200, SEATTLE, WA, 98101-3045, US

(21) Appl. No.: 10/579,145

(22) PCT Filed: Nov. 18, 2004
(86) PCT No.: PCT/US04/39134

§ 371 Date: Jun. 19, 2007

Related U.S. Application Data
(60) Provisional application No. 60/523,434, filed on Nov. 18, 2003.

(30) Foreign Application Priority Data
Nov. 18, 2003 (US) PCT/US03/36869

(51) Int. Cl. H01H 37/00

(52) U.S. Cl. 337/298; 310/311; 62/3.1

(57) ABSTRACT

The present disclosure concerns embodiments of a micro-transducer and a thermal switch used to control the transfer of heat into and away from the micro-transducer. In one embodiment, the thermal switch includes at least one drop of a thermally conductive liquid and is operate a to alternately establish a path of high thermal conductance and low thermal conductance between a micro-transducer and a heat source or heat sink via the drop. In another embodiment, the thermal switch includes at least one nanostructure (e.g., a bundle of carbon nanotubes), and is operable to alternately establish a path of high thermal conductance and low thermal conductance between a micro-transducer and a heat source or heat sink via the nanostructure. Also disclosed are embodiments of a thermal switch that can be selectively activated to alternately establish a path of high thermal conductance and low thermal conductance between a heat sink and a heat source.

### CROSS-REFERENCE TO RELATED APPLICATIONS

This application claims the benefit of U.S. Provisional Application No. 60/523,434, filed Nov. 18, 2003, which is incorporated herein by reference. This application also claims priority to PCT Application No. PCT/US2003/036869, filed Nov. 18, 2003, which claims the benefit of U.S. Provisional Application No. 60/427,619, filed Nov. 18, 2002. PCT Application No. PCT/US2003/036869 and U.S. Provisional Application No. 60/427,619 are incorporated herein by reference.

### FEDERAL SUPPORT

This invention was developed with support under Grant No. 99-80-837 from the National Science Foundation, Contract No. DASG60-02-C-0001 from the Defense Research Projects Agency, and Contract No. DASG60-02-C-0084 from the U.S. Army Space and Missile Defense Command. The U.S. government has certain rights in this invention.

### FIELD

This invention relates generally to embodiments of a micro-transducer and a thermal switch that can be used, for example, to control the heat transfer into and out of mechanical, electrical, and electromechanical devices.

### BACKGROUND

The need for miniaturized power sources for micro-electro-mechanical systems (MEMS) and micro-electronics has long been recognized. Much work has already been done on micro-scale batteries, and micro-scale heat engines. Micro-scale heat engines are a particularly attractive option, because of the very high density energy storage afforded by the hydrocarbon fuels they burn. Thus, a micro-heat engine which could convert the chemical energy stored in a hydrocarbon fuel to mechanical or electrical energy could form the basis of a very compact power supply.

Piezoelectric thin films have been used for years as power transducers in MEMS and micro-electronic devices. Piezoelectric films are an attractive option for power transduction because of the relative ease with which such devices can be produced using conventional micro-machining methods. Generally speaking, micro-machining involves processing techniques, such as microlithography and etching, that were developed and refined for use in the manufacture of integrated circuits. Micro-machining allows fine control of dimensions and is commonly employed for producing parts from silicon. However, micro-machining is not restricted in its application to the formation of workpieces from silicon or other materials conventionally used in the manufacture of integrated circuits, and it is known to apply micro-machining to other materials.

In most applications of piezoelectric films, such as in micro-actuators, pumps, and valves, electrical power is converted to mechanical power. Micro-sensors that utilize piezoelectric films also have been used for mechanical-to-electrical transduction, however, such devices are not capable of producing usable electrical power to any significant degree. Thus, it would be desirable to utilize piezoelectric thin films for converting energy in one form, such as thermal energy or kinetic energy, to useful electrical energy to power MEMS and micro-electronic devices.

Along with the need for miniaturized power sources is the need for micro-devices that are designed to remove heat from MEMS and micro-electronics. In particular, integrated-circuit manufacturers are already reaching limits on micro-processor speed and performance imposed by high operating temperatures. Consequently, reducing the operating temperatures of chips by removing waste heat through active cooling is considered to be among the most promising strategies available to the microprocessor industry for overcoming these obstacles. Thus, it would be desirable to implement a piezoelectric film in a micro-heat pump for cooling applications of MEMS and micro-electronics.

Many MEMS devices have been developed that rely on thermal energy for actuation. This energy can be supplied in a variety of ways. For example, there are micro-systems that receive heat from electrical resistance heaters, external sources, and chemical reactions. The ability to control the heat transfer into and out of these MEMS devices is essential to their performance. The necessity for precise thermal management is especially critical for micro-devices that operate at high frequencies, such as micro-thermopneumatic pumps, bi-layer electrical relays, and micro-heat engines. Often, it is the inability to rapidly reject heat that limits the operating frequencies of such devices. Thus, there is a strong need for a thermal switch that enables the precise control of heat transfer into and out of such MEMS devices.

### SUMMARY

The present disclosure concerns embodiments of a micro-transducer that can be used to convert energy in one form to energy in another form. For example, the micro-transducer can be operated as a micro-heat engine to convert heat energy into electrical energy or a micro-heat pump which consumes electrical energy to transfer heat from a heat source to a heat sink.

In particular embodiments, the micro-transducer comprises a fluid-tight cavity that contains a two-phase working fluid comprising a liquid and a gas. A deflectable membrane bounds at least a portion of cavity. The deflectable membrane is operable as an actuator to compress the working fluid whenever an electric field is applied to the membrane and operable as a generator to generate an electric charge whenever the working fluid expands. The deflectable membrane can be a piezoelectric transducer (e.g., a membrane comprising a piezoelectric material between two electrodes). A wick structure is formed on an inner surface of the cavity and holds a portion of the liquid. In an illustrated embodiment, the wick structure is formed on the inner surface of a stationary membrane of the micro-transducer. During use, heat can be added to the micro-transducer through the stationary membrane, causing substantially all of the liquid held in the wick structure to evaporate, and thereby increasing the overall volume of the working fluid. This causes the deflectable membrane to deflect outwardly and generate an electric charge.

The present disclosure also concerns embodiments of a thermal switch that is used to control the transfer of heat from a heat source to a heat sink. As used herein, the term “heat source” is used to refer to anything that gives off or rejects heat. The term “heat sink” is used to refer to anything that accepts or absorbs heat. According to one aspect, the thermal switch can be activated, or turned “on”, so as to establish a path of low thermal resistance between the heat source and the heat sink to facilitate the transfer of heat therebetween. The thermal switch can also be de-activated, or turned “off”, so as to establish a path of high thermal resistance between the heat source and the heat sink to minimize or totally prevent the transfer of heat between the heat source and heat sink.

The thermal switch can be implemented to control the flow of heat into and out of any of various mechanical, electrical, or electromechanical devices. In one implementation, for example, thermal switches control the flow of heat into and out of a micro-transducer, such as a micro-heat engine or a micro-heat pump. One thermal switch periodically thermally couples the micro-transducer to a heat source to allow heat to flow into the micro-transducer. Another thermal switch periodically thermally couples the micro-transducer to a heat sink to allow the micro-transducer to reject heat to the heat sink.

The micro-transducer can be arranged in a cascade of multiple micro-transducers, each operating over its own temperature range. The micro-transducers are thermally coupled to each other with thermal switches. Thus, in this configuration, heat rejected by one micro-transducer is transferred to another micro-transducer in an adjacent level of the cascade whenever a respective thermal switch thermally couples the micro-transducers to each other.

In one embodiment, the thermal switch comprises two opposed silicon contacts. The thermal switch is activated by bringing the contacts into contact with each other, which allows heat to be conducted from one contact to the other. The thermal switch is de-activated by creating a gap between the contacts, which increases the thermal resistance between the opposed surfaces, thereby inhibiting heat transfer.

In particular embodiments, the thermal switch includes at least one drop of a thermally conductive liquid, such as a liquid metal or liquid-metal alloy, positioned between the opposed surfaces of first and second thermally conductive members. The thermal switch is activated by bringing the drop into contact with the two surfaces, which allows heat to be conducted from one thermally conductive member to the other thermally conductive member through the drop. The thermal switch is de-activated by creating a gap between the drop and one of the surfaces, which increases the thermal resistance between the surfaces, thereby minimizing heat transfer.

The direction of heat transfer through the switch depends on the particular application in which the switch is being used. For example, if the first thermally conductive member is thermally coupled to a heat source and the second thermally conductive member is thermally coupled to a heat sink, heat is transferred from the first thermally conductive member to the second thermally conductive member through the drop whenever the thermal switch is activated.

In other embodiments, the thermal switch includes one or more nanostructures, such as one or more bundles of aligned carbon nanotubes, positioned between the opposed surfaces of first and second thermally conductive members. The thermal switch is activated by bringing the drop into contact with the ends of the nanostructures, which allows heat to be conducted from one thermally conductive member to the other thermally conductive member through the nanostructures.

The thermal switch can include an actuator that is operable to selectively activate and de-activate the thermal switch. In one embodiment, for example, the first thermally conductive member serves as a base for supporting a liquid drop (or a nanostructure) and the second thermally conductive member is a deflectable actuator, such as an electrostatic or piezoelectric transducer. In its normal, non-deflected position, the actuator is spaced from the drop to minimize heat transfer between the actuator and the base. To activate the thermal switch, the actuator is caused to deflect inwardly and contact the drop, thereby establishing a path of high thermal conductance between the actuator and the base. To de-activate the switch, the actuator is allowed to return to its non-deflected position.

In another embodiment, a thermal switch is operable to control the flow of heat into or away from a body. The thermal switch includes a drop of a thermally conductive liquid (or a nanostructure) and an activation element. The activation element is selectively movable between a first position to activate the thermal switch and to allow heat to flow into or away from the body, and a second position to de-activate the thermal switch to minimize the flow of heat into or away from the body.

According to another embodiment, a thermal-switch assembly comprises a first major layer and a second major layer. A plurality of thermal-switch elements are cooperatively formed between the first and second switch elements. Each thermal-switch element is selectively operable independently of each other to increase and decrease the transfer of heat between the first and second major layers.

In yet another embodiment, a thermal switch transfers heat from one surface to another surface of the switch through evaporation and condensation of a working fluid, in a manner similar to a conventional heat pipe. The thermal switch in this embodiment comprises a body that defines a fluid-tight cavity for containing the working fluid. A flexible membrane forms a wall of the cavity and is deflectable inwardly toward an opposed surface of cavity. The inner surface of the flexible membrane mounts one or more wicks configured to wick up working fluid that has condensed on the opposed surface of the cavity. During operation, heat applied to the flexible membrane causes fluid carried by the wicks to evaporate. The vapor flows across the switch and condenses on the opposed surface of the cavity, giving up latent heat. When all of the liquid on the wicks has evaporated, the flexible membrane is activated to deflect inwardly to cause liquid that has condensed to wick up onto the wicks.

Other exemplary applications for thermal switches are also disclosed. For example, a thermal switch can be used to control the transfer of heat in a thermoelectric cooler. In one representative embodiment, a thermoelectric cooler comprises a low-temperature heat source, a high-temperature heat sink, and a thermoelectric element that is thermally coupled to the high-temperature heat sink. A thermal switch comprising at least one drop of a thermally conductive liquid is configured to selectively thermally couple the low-temperature heat source to the thermoelectric element. By selectively thermally coupling the heat source to the thermoelectric element, the transfer of Joule heat to the heat source is avoided, which results in an overall increase in net cooling. In another embodiment, a thermal switch comprising at least one nanostructure is configured to selectively thermally couple the low-temperature heat source to the thermoelectric element.

In another application, one or more thermal switches can be used to selectively thermally couple a heat source and a cold source to micro-tubes of a thermal cycler, such as used to perform PCR analysis on DNA samples. According to one representative embodiment, a thermal cycler comprises a tube-support device that supports one or more micro-tubes for containing a sample to be processed by the thermal cycler. A heat source is configured to supply heat to the samples in the micro-tubes, and a cold source is configured to supply cold to the samples in the micro-tubes. A thermal switch is-configured to selectively thermally couple at least one of the heat source and cold source to the micro-tubes.

The foregoing and other features and advantages of the invention will become more apparent from the following detailed description of several embodiments, which proceeds with reference to the accompanying figures.

### BRIEF DESCRIPTION OF THE DRAWINGS

FIG. 1 shows an enlarged cross-sectional view of a piezoelectric micro-transducer according to one embodiment of the present invention.

FIG. 1A is a magnified cross-sectional view of the upper membrane of the micro-transducer shown in FIG. 1.

FIGS. 2A-2D illustrate the thermodynamic cycle of a piezoelectric micro-heat engine having the same general construction of the micro-transducer of FIG. 1, shown operating between a high-temperature heat source and a low-temperature heat sink.

FIG. 3 shows an enlarged cross-sectional view of a piezoelectric micro-heat pump having the same general construction of the micro-transducer of FIG. 1, shown operating between a low-temperature heat source and a high-temperature heat sink.

FIG. 4 is a top plan view of the backside of a first wafer of a pair of wafers used for constructing an array of piezoelectric micro-transducers, wherein the first wafer defines a plurality of square pits therein for forming the first membranes of the array of micro-transducers.

FIG. 5 is a partial, sectional view of an apparatus according to another embodiment, comprising pairs of first and second substrates stacked superposedly, with an array of identical piezoelectric micro-heat engines formed in each pair of substrates.

FIG. 6A is a cross-sectional view of a micro-transducer, according to another embodiment, having a wick structure formed on the inner surface of the bottom membrane.

FIG. 6B is a plan view of the inner surface of the bottom membrane and the wick structure of the micro-transducer of FIG. 6A.

FIG. 6C is a plan view of another embodiment of a wick structure formed on the inner surface of a membrane.

FIG. 7 is a graph of an exemplary output voltage generated by a micro-heat engine operating at 20 Hz.

FIG. 8 is a graph of an exemplary output voltage generated by a micro-heat engine operating at 50 Hz.

FIG. 9A is a plot illustrating exemplary temperature differences measured across the contacts of a silicon-silicon-contact thermal switch operating at different applied thermal loads (power input).

FIG. 9B is a graph of an exemplary temperature of one contact of a silicon-silicon-contact thermal switch and a graph of the position of the other contact of the thermal switch.

FIGS. 10A and 10B are cross-sectional views of a liquid-droplet thermal switch, according to one embodiment, shown in a de-activated state (FIG. 10A) and an activated state (FIG. 10B).

FIGS. 11A and 11B are cross-sectional views of a liquid-droplet thermal switch, according to another embodiment, shown in a de-activated state (FIG. 11A) and an activated state (FIG. 11B).

FIG. 12 is a partial, sectional view of an another embodiment of an apparatus comprising arrays of piezoelectric micro-heat engines stacked superposedly in a cascade, in which micro-droplet thermal switches control the flow of heat into and out of the micro-heat engines.

FIG. 13A is a top plan view of a thermal-switch assembly, according to one embodiment, that includes an array of independently actuatable thermal-switch elements.

FIG. 13B is a cross-sectional view of the thermal-switch assembly of FIG. 13A taken along line 13B-13B.

FIG. 14 is a schematic illustration of a thermoelectric cooler, according to one embodiment, that includes a thermal-switch assembly to control the transfer of heat between the cold side of the thermoelectric cooler and the thermoelectric element of the thermoelectric cooler.

FIG. 15 is a schematic illustration of a thermal cycler, according to one embodiment, that includes thermal-switch assemblies to control the flow of heat and cold to samples contained in micro-tubes supported in the thermal cycler.

FIGS. 16A and 16B are cross-sectional views of another embodiment of a thermal switch shown in different stages of operation.

FIGS. 17A and 17B are cross-sectional views showing two micro-heat engines stacked in a cascade configuration, in which a thermal switch similar to that shown FIGS. 16A and 16B is defined between the micro-heat engines.

FIG. 18 is a schematic illustration of a deposition chamber used to form mercury droplets usable in various thermal switch embodiments.

FIG. 19 is a graph showing the steady-state heat transfer across a 400-droplet thermal switch under different applied loads.

FIG. 20 is a graph showing the steady-state heat transfer across a 1600-droplet thermal switch under different applied loads.

FIG. 21 is a graph showing the thermal resistance of a 400-droplet thermal switch and a 1600-droplet thermal switch under different applied loads.

FIG. 22 is a graph showing the heat transfer across a 1600-droplet thermal switch for different air-gap distances between the droplets and one side of the switch.

FIG. 23 is a plot of the average thermal resistances for the air-gap distances shown in FIG. 22.

FIG. 24A is a plot of exemplary thermal resistances exhibited by a 1600-droplet thermal switch as a function of applied load when operated at atmospheric pressure, a plot of exemplary thermal resistances exhibited whenever a vacuum is established inside the switch, and a plot of exemplary thermal resistances exhibited whenever argon gas is contained inside the switch.

FIG. 24B is a plot of exemplary thermal resistances of a 1600-droplet thermal switch as a function of applied load and gap distances whenever the switch is operated at atmospheric pressure and a plot of exemplary thermal resistances exhibited whenever a vacuum is established inside the switch.

FIGS. 25A and 25B are elevational cross-sectional views of a thermal switch employing nanostructures, according to one embodiment, shown in a de-activated state (FIG. 25A) and an activated state (FIG. 25B).

FIG. 26A is a plan view of a thermal switch assembly, according to another embodiment, that includes an array of independently actuatable thermal-switch elements, wherein each thermal switch has at least one nanostructure that serves as a conduit for conducting heat.

FIG. 26B is a cross-sectional view of the thermal switch assembly of FIG. 26A taken along line 26B-26B.

FIG. 27 is a partial, sectional view of another embodiment of an apparatus comprising arrays of piezoelectric micro-heat engines stacked superposedly in a cascade, in which nanostructures serve as conduits for controlling the flow of heat into and out of the micro-heat engines.

### DETAILED DESCRIPTION

As used herein, the singular forms “a,” “an,” and “the” refer to one or more than one, unless the context clearly dictates otherwise.

As used herein, the term “includes” means “comprises.”

As used in this description, the term “transducer” is used to denote a device for converting useful energy in one form to useful energy in another form. For example, energy may be converted from the energy of mechanical motion to an electric current or from thermal energy to mechanical motion. Additionally, it is known that many transducers that can be operated in one mode can also be operated in a reverse mode. As an example, a device may be operated both as an electrical motor to convert energy from electric current to mechanical motion, or it may be operated as a generator to convert mechanical motion to electric current.

As used herein, “piezoelectric materials” refer to those materials in which a mechanical stress applied as a result of, for example, bending, deflection, or flexure, produces an electrical polarization, and conversely, an applied electric field induces a mechanical strain that causes a mechanical displacement of the material (e.g., in the form of bending, deflection, or flexure).

As used herein, the term “substrate” refers to any support material from which one or more micro-transducers can be constructed and is not limited to materials, such as silicon wafers, conventionally used in the manufacture of semiconductor devices.

As used herein, the term “body” refers to anything that can function as a heat source by rejecting or giving off heat and/or as a heat sink by accepting or absorbing heat.

### Micro-Heat Engine/Micro-Heat Pump

According to one aspect, a micro-transducer can be used either as a micro-heat engine to convert thermal energy, flowing from a higher temperature to a lower temperature, into electric current or as a micro-heat pump, i.e., a micro-refrigerator, that consumes electric energy to pump thermal energy from a lower temperature to a higher temperature. The micro-transducer has particular applicability for use as a micro-heat engine for providing electrical power to MEMS or micro-electronic devices, for example, or as a micro-heat pump to remove heat from MEMS or micro-electronic devices.

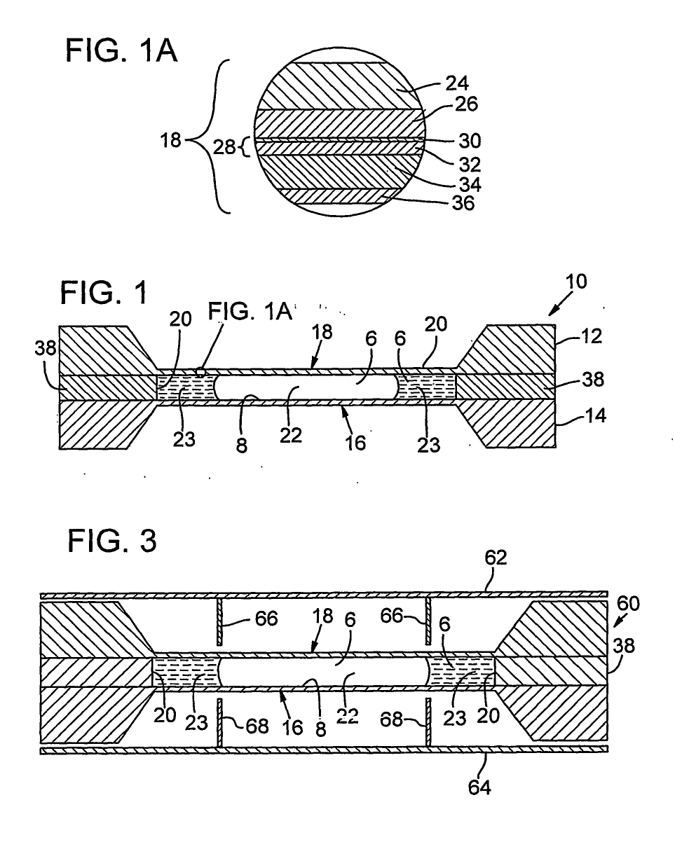

FIG. 1 shows an enlarged cross section of a micro-transducer 10 according to a one embodiment. The micro-transducer 10 in the illustrated configuration has a cell-like structure that comprises a first major layer 12 and a second major layer 14. The micro-transducer 10 has a generally rectangular shape, although in other embodiments the micro-transducer 10 may be circular or any of other various shapes. In a working embodiment, the first and second major layers 12 and 14 comprise silicon wafers. However, the micro-transducer 10 may be fabricated from materials other than silicon, such as quartz, sapphire, plastic, ceramic, or a thin-film metal such as aluminum. Methods for manufacturing the micro-transducer 10 from a silicon wafer or other equivalent material are described in detail below.

A fluid cavity 8 is cooperatively formed between the first major layer 12 and the second major layer 14. In the present embodiment, for example, the fluid cavity 8 is bounded by a first membrane 18 (shown as an upper membrane 18 in FIG. 1) of the micro-transducer 10, a second membrane 16 (shown as a lower membrane 16 in FIG. 1) of the micro-transducer 10, and side walls 20. The second membrane 16 comprises a recessed portion, or an area of reduced thickness, defined in the second major layer 14. The first membrane 18 similarly comprises a recessed portion, or an area of reduced thickness. The side walls 20 are defined by a generally rectangular aperture formed in an intermediate layer 38 disposed between the first major layer 12 and the second major layer 14.

A working fluid 6 is contained within the fluid cavity 8. As shown in FIG. 1, the working fluid 6 may comprise two phases including a saturated vapor 22 and a saturated liquid 23. Desirably, the working fluid employed in the micro-transducer 10 is selected so that it remains a saturated liquid-vapor mixture throughout the thermodynamic cycle of the micro-transducer 10. The selection of the particular two-phase working fluid will depend upon the working temperatures of the micro-transducer 10. For example, in relatively low-temperature applications (i.e., less than 200° F.), refrigerants such as R11 (a CFC refrigerant) have proven to be suitable. In moderate-temperature applications (i.e., above 200° F.), water may be used as the two-phase working fluid. Although less desirable for reasons explained below, the working fluid 6 may be comprised entirely of a vapor or a liquid.

In any event, the use of a two-phase working fluid is significant in that the thermal efficiency attained by the transducer approaches that of the ideal Carnot cycle. In conventional large-scale heat engines and heat pumps, two-phase fluids cannot be used because surface tension causes the liquid portion of a two-phase saturated mixture to form small droplets that can quickly destroy thermal machinery during expansion and compression processes. In the present embodiment, however, the use of a two-phase working fluid is possible because of the surface tension forces that occur on the micro-scale. Specifically, and as shown in FIG. 1, surface tension causes the liquid portion 23 to separate from the vapor portion 22 and adhere to the inside walls 20 of the transducer 10 so as to prevent the formation of liquid droplets that would otherwise harm the transducer.

In FIG. 1A, the depicted magnified section of FIG. 1 illustrates that the first membrane 18 desirably includes a support layer 24 which comprises the material of the first major layer 12 (e.g., silicon in the present example). An optional silicon oxide layer 26 is juxtaposed to the support layer 24; a first electrode 28 (shown as a top electrode in FIG. 1A) is juxtaposed to the oxide layer 26; a piezoelectric member or layer 34 is juxtaposed to the top electrode; and a second electrode 36 (shown as a bottom electrode in FIG. 1A) is juxtaposed to the bottom electrode 36. The support layer 24, oxide layer 26, top electrode 28, piezoelectric layer 34, and bottom electrode 36 collectively define the first membrane 18.

The first and second electrodes 28, 36, respectively, may comprise any suitable material. In a working embodiment, for example, the bottom electrode 36 comprises a layer of gold (Au). The first electrode 28 comprises a first layer 32 of platinum (Pt) and an optional second layer 30 of titanium (Ti) to facilitate adhesion of the platinum layer to the silicon oxide layer 26. The piezoelectric layer 34 may be made from any material having sufficient piezoelectric properties, such as lead zirconate titanate (PZT) or zinc oxide (ZnO).

The intermediate layer 38 comprises, for example, a layer of photoresist material, such as SU-8 (available from Shell Chemical Co.). An aperture is formed in the photoresist material so as to form the side walls 20 of the micro-transducer 10. The second membrane 16 of the micro-transducer 10 comprises the material of the second major layer (e.g., silicon in the present case). The second membrane 16 has a thickness greater than that of the first membrane 18, and therefore the second membrane 16 is generally more rigid than the first membrane. Consequently, the first membrane 18 flexes inwardly and outwardly while the second membrane 16 retains a substantially constant profile during operation of the micro-transducer 10.

Generally speaking, the piezoelectric layer 34 together with the electrodes 28 and 36 define a piezoelectric unit that functions as both a piezoelectric actuator (converting electrical work to mechanical work) and as a piezoelectric generator (converting mechanical work to electrical work). For operation as an actuator, a voltage applied to the top and bottom electrodes 28, 36, respectively, causes the piezoelectric layer 34, and thereby the first membrane 18, to flex inwardly, thereby compressing the vapor phase 22 of the working fluid 6. Conversely, for operation as a generator, a voltage is generated across the top and bottom electrodes, 28 and 36, respectively, whenever the vapor phase 22 of the working fluid 6 expands to cause the piezoelectric layer 34, and thereby the first membrane 18, to flex outwardly. Thus, the first membrane 18 flexes in and out, alternately expanding and compressing, respectively, the vapor phase of the working fluid contained within the transducer. Unlike sliding and rotating parts in conventional machinery, however, the micro-transducer 10 eliminates the problem of dissipative losses due to sliding friction. Further details of the operation and design of the micro-transducer 10 are described below, first with reference to a micro-heat engine and then with reference to a micro-heat pump.

### Micro-Heat Engine

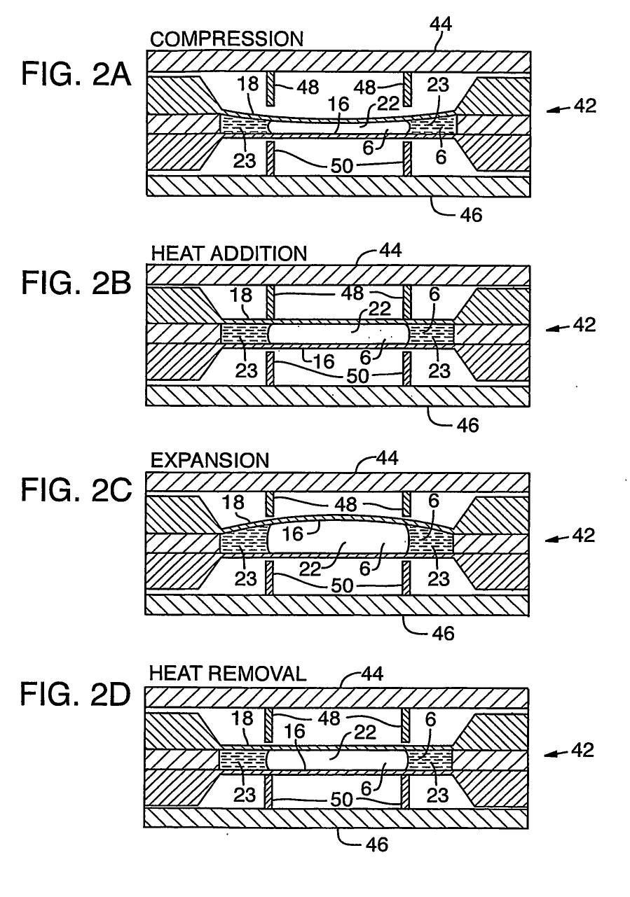

FIGS. 2A-2D illustrate the thermodynamic cycle of a heat engine 42, according to one embodiment, operating between a high-temperature heat source 44 and a low-temperature heat sink 46. In the illustrated embodiment, the high-temperature heat source 44 has one or more thermal switches, or contacts, 48 operable to periodically thermally couple the first membrane 18 to the high-temperature heat source 44. Similarly, the low-temperature heat sink 46 has one or more thermal switches, or contacts, 50 operable to periodically thermally couple the second membrane 16 with the low-temperature heat sink 46. Preferably, the thermal contacts 48, 50 are dimensioned to contact the membranes 16, 18 of the heat engine physically so as to maximize heat transfer into and out of the heat engine.

The thermal contacts 48, 50 can be made of silicon or various other materials exhibiting good thermal conductivity. As shown, the thermal contacts 48, 50 in the illustrated embodiment are generally rectangular structures extending from the heat source 44 and the heat sink 46. However, the thermal contacts can have any of various other geometric shapes. For example, the thermal contacts can have a generally flat cross-sectional profile.

The thermodynamic cycle of the heat engine 42, which is based on the Carnot vapor cycle, consists of the following four processes: (1) compression, (2) high-temperature heat-addition, (3) expansion and electrical power production, and (4) low-temperature heat-rejection. During this four-process cycle, the first membrane 18 of the heat engine 42 completes one full oscillation.

The first process of the cycle, compression, is represented by FIG. 2A. In the compression stroke of an initial cycle, an electrical switch (not shown) connected to the top and bottom electrodes 28 and 36 (FIG. 1A) is closed to generate a voltage across the piezoelectric layer 34 (FIG. 1A). The applied voltage causes the piezoelectric layer 34 (FIG. 1A), and thereby the first membrane 18, to flex downwardly toward the second membrane 16, thereby compressing the vapor 22. As the overall volume of the working fluid 6 decreases, the pressure of the working fluid 6 increases, which results in a corresponding increase in temperature. At the end of the compression process, the electrical switch is opened, causing the piezoelectric layer 34 to become a capacitor that stores any charge accumulated on the electrodes 28, 36 during the time period in which the voltage was applied.

During the second process, high-temperature heat-addition, the high-temperature heat source 44 is thermally coupled to the first membrane 18 via thermal switches 48 to transfer thermal energy to the heat engine 42 by conduction (as shown in FIG. 2B). As heat moves into the working fluid 6, some of the liquid portion 23 of the working fluid 6 vaporizes, thereby increasing the overall volume the working fluid 6 and causing an upward displacement of the 10 first membrane 18. With the upward displacement of the first membrane 18, the applied strain increases the dipole moment of piezoelectric layer 34 (FIG. 1A), which in turn causes an increase in the open-circuit voltage of the electrodes 28 and 36 (FIG. 1A). At the end of the heat-addition process, the temperature and pressure in the working fluid 6, as well as the open-circuit voltage across the electrodes 28 and 36, will have reached their respective maximum values of the working cycle.

Referring to FIG. 2C, there is shown the third process, expansion and electrical power production from the coupling with heat source 44 in FIG. 2B. In this process, the previously described electrical switch (not shown) is closed to allow for the removal of the electric charge stored in the electrodes 28 and 36 (FIG. 1A). The resulting electric current flows from the electrodes to, for example, an electronic power conditioner (not shown), where the energy can be made available in a form usable by micro-electronic devices or MEMS. As charge is drained from the electrodes 28 and 36, the modulus of elasticity and the resulting strain of the piezoelectric layer 34 (FIG. 1A) decrease from a higher open-circuit value to a lower closed-circuit value. Accordingly, the piezoelectric layer 34 (FIG. 1A) relaxes, which allows the first membrane 18 to flex upwardly under the pressure of the working fluid 6. The vapor 22 of the working fluid 6 therefore expands as pressure and temperature decrease until the first membrane 18 reaches its point of greatest outward deflection, as shown in FIG. 2C.

During the fourth process, low-temperature heat-rejection, the low-temperature heat sink 46 is thermally coupled to the second membrane 16 via thermal switches 50 to remove thermal energy from the heat engine 42 through conduction (as shown in FIG. 2D). As heat is removed from the heat engine 42, some of the vapor 22 condenses, which causes a decrease in the volume of the working fluid 6. Such decrease in the volume of the working fluid 6 results in a return deflection of the first membrane 18 and a corresponding decrease in strain in the piezoelectric layer 34 (FIG. 1A). Since the low-temperature heat-rejection process occurs with the electrical switch closed and no external voltage being applied, the piezoelectric layer 34 is short-circuited. As a result, no charge can accumulate in the piezoelectric layer 34 (FIG. 1A), and the modulus of elasticity of the piezoelectric layer 34 (FIG. 1A) returns to its higher open-circuit value to assist return of the first membrane 18 to its inwardly deflected position of FIG. 2A. Following the heat-rejection process, the thermodynamic cycle then repeats itself, starting again with the compression process.

The efficiency of the mechanical-to-electrical conversion in the piezoelectric layer 34 will depend strongly upon how closely the frequency of oscillation of the first membrane 18 matches its resonant mechanical frequency. This is because only a portion (about one-tenth) of the mechanical energy transferred into the piezoelectric layer 34 as strain is converted into electrical energy (the remaining portion of mechanical energy is stored as spring energy). Thus, if the heat engine 42 is operated at or near the resonant mechanical frequency of the first membrane 18, mechanical energy not converted to electrical energy but stored as spring energy can be reclaimed later in the cycle. In particular, this stored spring energy can be used to achieve compression (process one, FIG. 2A) of the working fluid subsequent to the initial cycle. Such recovery of the strain energy will effect a substantial increase in engine efficiency since compression is accomplished without drawing current from an outside source. Conversely, operating with an oscillation frequency not equal to the resonant frequency will result in the loss of some or all of this stored spring energy, accompanied by a subsequent loss of engine efficiency.

Since thermal energy is transferred into the heat engine 42 from an external source, the heat engine 42 operates in a manner that is similar to that of a large-scale external-combustion engine. However, unlike conventional large-scale external-combustion engines, the working fluid does not circulate from the heat engine 42 to a separate heat-exchanger. Instead, heat is alternately transferred in and out of the heat engine via conduction through the second and first membranes 16, 18, while the working fluid remains inside the heat engine 42. In essence, the heat engine 42 functions as its own heat-exchanger, which is a consequence of the large surface-to-volume ratio that can be achieved on the micro-scale level. Thus, it should be apparent that the micro-heat engine 42 integrates all heat-engine functions into a self-contained cell-like structure. Such a design solution would be impossible in a large-scale engine.

Although a single heat engine 42 may be sufficient to supply the power requirements for certain applications, multiple heat engines may be connected in parallel to increase power output. For example, if one heat engine operating-at a predetermined cycling frequency generates one milliwatt, then ten heat engines connected in parallel and operating at the same frequency would generate ten milliwatts. It is then possible to provide a power source that is operable to generate anywhere from one milliwatt to several watts of power, or more, by varying the number of heat engines.

Referring to FIG. 5, for example, there is shown an apparatus 70 comprising pairs 72 of first and second substrates 74, 76, respectively, (e.g., pairs of silicon wafers) stacked superposedly with respect to each other so as to form a system of cascading levels, each of which operating over its own temperature differential. An array of identical heat engines 42 are micro-machined into each pair 72 of first and second substrates 74 and 76, respectively, and an intermediate layer 80 (e.g., a layer of photoresist material) is disposed between each pair of substrates. In this arrangement, each heat engine 42 is aligned with another heat engine 42 of an adjacent level, with an intervening insulating layer of air. Each heat engine 42 comprises a flexible first membrane 18 having a piezoelectric unit (i.e., a piezoelectric layer disposed between two electrodes) and a substantially rigid second membrane 16. Thermal switches or contacts 78 may be positioned on the second membranes 16 of the heat engines 42.

A high-temperature heat source 82 is positioned adjacent to the second membranes 16 of the level operating in the highest temperature range in the cascade (shown as the uppermost pair 72 of substrates 74 and 76 in FIG. 5). The high-temperature heat source 82 is operable to periodically thermally contact the adjacent second membranes 16. Thermal contacts 78 may be disposed on the high-temperature heat source 82 for contact with the adjacent second membranes 16. Similarly, a low-temperature heat sink 84 is positioned adjacent to the first membranes 18 of the level operating in the lowest temperature range (shown as the lowermost pair 72 of substrates 74 and 76 in FIG. 5). The low-temperature heat sink 84 is operable to periodically thermally contact the adjacent first membranes 18. Similarly to the high-temperature heat source 82, the low-temperature heat sink may include thermal contacts 78. Thus, thermal energy is conducted through the apparatus 70 in the direction indicated by arrow 86.

In FIG. 5, the apparatus 70 is operated so that the thermodynamic cycles of the heat engines 42 are synchronized. That is, each heat engine 42 in a particular level desirably undergoes the same process of the-thermodynamic cycle at the same time. However, each level desirably operates 180° out of phase from the adjacent level(s). For example, whenever the heat engines 42 of one level undergo a heat-addition process, the heat engines 42 of an adjacent level undergo a heat-rejection process. Thus, the first membrane 18 of each heat engine 42 serves as the high-temperature heat source for the high-temperature heat-addition process (process two) of a heat engine 42 in an adjacent level of a lower temperature range. Similarly, the second membrane 16 of each heat engine 42 serves as the low-temperature heat sink for the low-temperature heat-rejection process (process four) of a heat engine 42 in an adjacent level of a higher temperature range. The thermal switches 78 are positioned on the second membranes 16 to facilitate conduction of thermal energy from the first membranes 18 to respective second membranes 16 in an adjacent level of a lower temperature range.

The use of a cascading arrangement is advantageous because the temperature differential of each heat engine 42 is relatively small due to the limited expansion and compression ratio that can be achieved with the piezoelectric member. Thus, by configuring a cascade of heat engines 42, it is possible to provide a power source that works over any arbitrarily large temperature range. Operating in a cascading arrangement is also desirable in that it is possible to select a working fluid 6 that is most appropriate for the pressure and temperature range of a particular level.

To ensure that there is adequate heat transfer through the heat engine 42, the dimensions of the heat engine 42 desirably, although not necessarily, provide for a low aspect ratio (i.e., a low thickness-to-width ratio) in order to maximize heat-transfer area and minimize conduction-path lengths. A suitable aspect ratio that is sufficiently low can be obtained with a heat engine having first and second membranes each having a thickness of about 5 microns (μm) or less. The thickness of the engine cavity 8, i.e., the distance between the membranes 16, 18, desirably is about 50 microns or less. As such, the working fluid in the engine cavity 8 will be in the form of a thin layer. In contrast, the lengths of the membranes desirably are relatively larger than their thicknesses, for example, between 1 to 5 mm, although larger or smaller membranes may be used.

### EXAMPLE 1

In one example of a micro-heat engine 42, the first membrane 18 has a thickness of about 2 microns, the second membrane 16 has a thickness of about 5 microns, and the thickness of the engine cavity is about 25 microns. The total length of the conduction path through the heat engine is therefore about 32 microns. The surfaces of the second and first membranes have dimensions of approximately 2.0 millimeters by 2.0 millimeters, which provides an aspect ratio of about 0.0160 and a heat-transfer area of 4.0 mm² at each membrane. It has been found that the foregoing dimensions will ensure a maximum surface-area-per-unit volume of working fluid and a conduction path sufficiently short to drive heat through the heat engine. The thicknesses of the silicon layer 24 and the silicon oxide layer 26 of the first membrane 18 are about 600 nm and 400 nm, respectively. The top electrode 18 comprises a 20-nm thick layer of Ti and a 200-nm thick layer of Pt. The piezoelectric member 34 comprises a 500-nm thick layer of PZT. The bottom electrode comprises a 200-nm thick layer of Au. The working fluid is R11 refrigerant

Of course, those skilled in the art will realize that the foregoing dimensions (as well as other dimensions provided in the present specification) are given to illustrate certain aspects of the invention and not to limit them. These dimensions can be modified as needed in different applications or situations.

### Micro-Heat Pump

By reversing the operating cycle of the heat engine 42 shown in FIGS. 2A-2D, the heat engine can be used as a micro-heat pump or refrigerator. Referring now to FIG. 3, there is shown a heat pump 60, having the same general construction as the micro-transducer 10 of FIG. 1, operating between a low-temperature heat source 62 and a high-temperature heat sink 64. In the illustrated embodiment, the high-temperature heat sink 64 comprises thermal switches 68 for periodically thermally coupling the second membrane 16 with the high-temperature heat sink 64. Similarly, the low-temperature heat source 62 has thermal switches 66 for periodically thermally coupling the first membrane 18 to the low-temperature heat source 62.

During the working cycle of the heat pump 60, low-temperature thermal energy is transferred into the heat pump 60 from the low-temperature heat source 62 by conduction. By compressing the vapor 22 of the working fluid 6, the low-temperature thermal energy is transformed into high-temperature thermal energy, which is then transferred out of the heat pump 60 to the high-temperature heat sink 64 by conduction. According to the reverse order of the ideal Carnot vapor cycle, the thermodynamic cycle of the heat pump 60 is characterized by four processes: (1) compression, (2) high-temperature heat rejection, (3) expansion, and (4) low-temperature heat absorption. As with the heat engine 42, the first membrane 18 of the heat pump 60 completes one full oscillation during the cycle.

At the beginning of the first process, compression, the volume of the heat pump cavity is at its point of greatest volume, and the first membrane 18 is at its point of maximum outward deflection. Compression is accomplished by closing an electrical switch (not shown) connected to the top and bottom electrodes 28 and 36 (FIG. 1A) to generate a voltage across the piezoelectric layer 34 (FIG. 1A). When the voltage is applied, the piezoelectric layer 34 functions as an actuator, causing the first membrane 18 to flex downwardly toward the second membrane 16 and thereby compress the vapor 22. As the overall volume of the working fluid 6 decreases, the pressure of the working fluid 6 increases, which results in a corresponding increase in temperature. At the end of the compression process, the electrical switch is opened, causing the piezoelectric layer 34 to become a capacitor that stores any charge accumulated on the electrodes during the time the voltage was applied.

During the second process, high-temperature heat rejection, the high-temperature heat sink 64 is thermally coupled to second membrane 16 via thermal switches 68 to remove thermal energy from the heat pump 60 through conduction. As heat is removed from the heat pump 60, some of the vapor 22 condenses, which causes a decrease in the volume of the working fluid 6. The temperature and pressure of the working fluid 6, however, remain constant because the working fluid is a saturated mixture of liquid and vapor. The decrease in the volume of the working fluid 6 allows the first membrane 18 to flex further toward the second membrane 16. Since this process occurs with the electrical switch open, the dipole moment of the piezoelectric layer 34, and thus the open-circuit voltage of the electrodes 28 and 36, decrease as the first membrane 18 flexes inward.

The third process, expansion, begins with the working fluid 6 being compressed to its smallest possible volume and the first membrane 18 at its point of maximum inward deflection. To commence the expansion process, the electrical switch is closed to allow for the removal of the electric charge stored in the electrodes 28 and 36. As charge is drained from the electrodes 28 and 36, the modulus of elasticity and the resulting strain of the piezoelectric layer 34 decreases from a higher open-circuit value to a lower closed-circuit value. Accordingly, the piezoelectric layer 34 relaxes, which allows the first membrane 18 to flex upwardly under the pressure of the working fluid 6. The working fluid 6 thus expands as pressure and temperature decrease until the first membrane 18 reaches its neutral point, or point of zero deflection.

Unlike conventional large-scale heat pumps, e.g., vapor compression and adsorption machines, which utilize a throttling valve to expand the working fluid in an isenthalpic process without producing any work, the micro-heat pump 60 produces work during the expansion process in the form of an electric current flowing from the electrodes 28, 36. By extracting work, the micro-heat pump 60 provides for the expansion of the working fluid 6 in a substantially isentropic process, which is significant for two reasons. First, the extraction of work in an isentropic process causes the internal energy and the temperature of the working fluid 6 to drop more than in an isenthalpic throttling process. As such, more cooling will result. Second, the efficiency of the cycle can be increased if the electric current generated during the expansion is used to offset the power required to compress the working fluid 6 in the first process.

During the fourth process, low-temperature heat absorption, the low-temperature heat source 62 is thermally coupled to the first membrane 18 via thermal switches 66 to transfer thermal energy to the heat pump 60 through conduction. As heat moves into the working fluid 6, some of the liquid portion 23 of the working fluid vaporizes, thereby increasing the volume of the working fluid 6. This causes an upward displacement of the first membrane 18 and an electrical current to flow from the electrodes 28 and 36. As in the heat-rejection process (process two), the temperature and pressure remain constant because the working fluid 6 is a saturated mixture of liquid and vapor. Following the heat-absorption process, the thermodynamic cycle then repeats itself, starting again with the compression process.

As with the heat engine 42 of the present-invention, the heat pump 60 integrates all heat-pump functions into self-contained cell-like structure. Also, similar to the system of cascading heat engines 42 of FIG. 5, multiple heat pumps 60 may be arranged in a similarly configured system of cascading levels in order to increase the rate of cooling and the temperature differential obtainable using only a single heat pump. As an example, if a single heat pump 60 cools a cold space by 10° C., then ten similar heat pumps 60 stacked in a cascade array may cool the lowermost cold space of the cascade by 100° C. In addition, if a single heat pump 60 transfers 0.1 Watt of thermal power out of a cold space, then ten heat pumps 60 deployed in parallel may transfer 1.0 Watt of thermal power out of the same cold space.

The dimensions suggested for the heat engine 42 may also be used for the heat pump 60. Again, to ensure that there is adequate heat-transfer area through the heat pump, the dimensions desirably provide for a low aspect ratio.

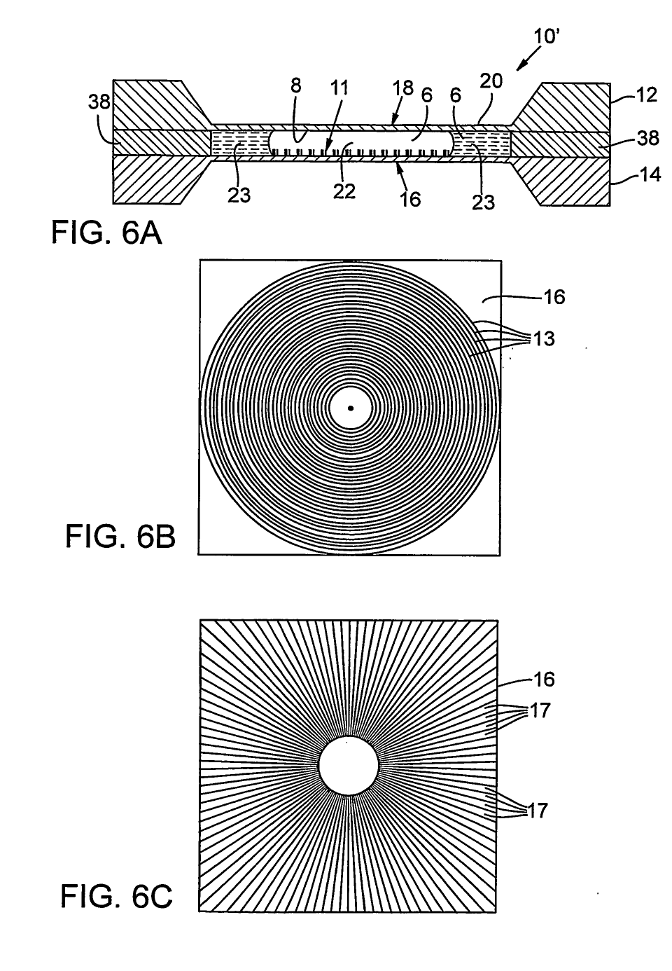

FIG. 6A illustrates a micro-transducer 10′, according to another embodiment, that has the same general configuration as the micro-transducer 10 shown in FIG. 1. Thus, components in FIG. 1 that are identical to respective components in FIG. 6A have the same respective reference numerals and are not described further. The difference between the micro-transducer 10′ of FIG. 6A and the micro-transducer 10 of FIG. 1 is that the former includes a wick structure 11 formed on the inner surface of the second membrane 16.

The wick structure 11 is configured to hold at least a portion of the liquid phase 23 of the working fluid 6 against the inner surface of the second membrane 16. As shown in FIG. 6B, the wick structure 11 in the illustrated embodiment comprises a series of radially spaced, generally concentric wicks 13 formed on the inner surface of the second membrane 16 so as to define a series of grooves therebetween. In particular embodiments, the wicks 13 are about 5 to 10 microns in height and have a width in the radial direction of about 5 to 20 microns, with 10 microns being a specific example. The spacing between adjacent wicks 13 is about 5 to 20 microns, with 10 microns being a specific example. Of course these dimensions can be varied as needed in different applications or situations.

In an alternative embodiment, as shown in FIG. 6C, the wick structure can define a series of radially extending, angularly spaced wicks 17. The wicks 17 can have a width that tapers from the periphery of the membrane 16 toward the center of the membrane as shown. Alternatively, the wicks can have a substantially constant width from the center to the periphery of the membrane 16. In particular embodiments, the wicks 17 are about 5 to 10 microns in height and have a width in the range of about 5 to 20 microns. The spacing between adjacent wicks 13 is about 5 to 20 microns, with 10 microns being a specific example.

Additionally, the wick structure can have various other configurations. For example, the wick structure can comprise a plurality of spaced-apart, substantially straight or linear wicks.

The wick structure 11 desirably is made from a hydrophilic material, such as a photoresist material (e.g., SU-8) or an electroplated metal. The wick structure 11 can be formed using conventional techniques. In one embodiment, for example, a 5 to 10-micron thick layer of photoresist is applied to the membrane 16 using a suitable technique such as sputter-coating or spin-coating. The photoresist layer is patterned using photolithography and etched to define the wicks 13 (FIG. 6B) or the wicks 17 (FIG. 6C). Any of various other micro-machining techniques also can be used to form the wick structure 11.

During use, at least a portion of the liquid 23 collects in the grooves between adjacent wicks 13 and adjacent wicks 15 to form a liquid film on the second membrane 16. As heat is added to the micro-transducer 10′ by thermally contacting the membrane 16 to a heat source (e.g., during the heat-additional process of a thermodynamic cycle), the liquid in the wick structure 11 evaporates more efficiently, and therefore increases the overall efficiency of the micro-transducer.

In an alternative embodiment, the wick structure can be formed on the inner surface of the second membrane 18. Thus, in this alternative embodiment, heat would be added to the micro-heat engine via the second membrane 18 during operation of the micro-heat engine.

### Fabrication Methods for the Micro-Heat Engine and Micro-Heat Pump

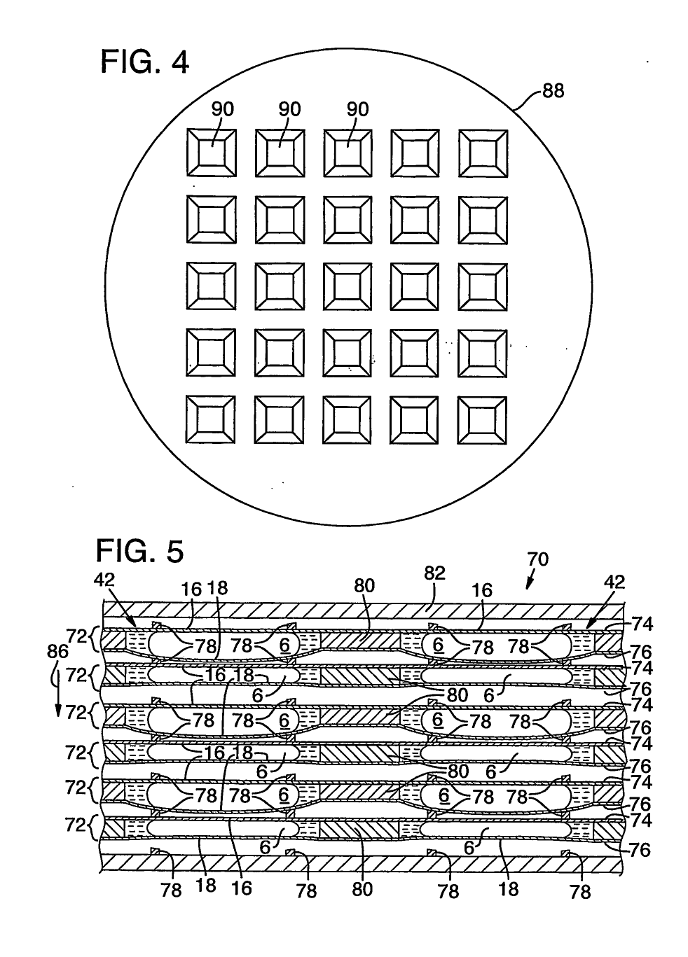

Using conventional micro-manufacturing techniques, an array of micro-transducers can be constructed from a pair of silicon wafers. Referring to FIG. 4, a first wafer 88 of a pair of silicon wafers, each being in the (001) crystal-lattice orientation and polished on both sides, is provided to form the first membranes 18 of an array of micro-transducers 10. First, thermal oxide is grown on both sides of the wafer 88. Then, a pattern of squares each oriented in the <100> direction is defined, for example, using conventional lithography on the backside of the first wafer. The oxide is then removed via wet chemical etching and the first wafer 88 is placed in an anisotropic etchant, such as ethylene diamine pyrochatecol (EDP), which preferentially removes silicon on a {001} plane compared to a {111} plane. Etching causes a plurality of pits 90 to be defined where the oxide had been removed. The first wafer 88 is removed from the etchant when approximately 50 microns of silicon remains at the bottom of each pit 90. A layer of 20-nm thick titanium is then deposited on the non-etched oxide side using physical vapor deposition, and a layer of 200-nm thick platinum is then grown over the layer of titanium using physical vapor deposition. The titanium and platinum layers will form the top electrode 28 of each transducer 10 formed in the wafers.

To form the piezoelectric layer 34 for each micro-transducer 10, a solution deposition route for PZT deposition is carried out on the first wafer 88. First, a solution containing the stoichiometric ratio of Pb, Zr, and Ti required for forming the Perovskite phase is spin-coated onto the layer of platinum. The first wafer 88 is then heated in air to 100° C. for 5 minutes and to 350° C. for 5 minutes. The spin-coating and heating processes are repeated until the PZT layer is about 500 nm thick, after which the first wafer 88 is heated in a furnace to 700° C. for 15 minutes. The steps of spin-coating and heating the wafer 88 in air to 100° C. for 5 minutes and to 350° C. for 5 minutes are repeated until the final thickness of the piezoelectric layer 34 is achieved, which desirably is about 500 nm. Once the final thickness of the piezoelectric layer 34 is achieved, the first wafer 88 is again heated in a furnace to 700° C. for 15 minutes.

To form the bottom electrodes 36 of the micro-transducers 10, a 200-nm thick layer of gold is deposited on the PZT surface via physical vapor deposition. The first wafer 88 is then placed into another anisotropic etchant in which the remaining 50 microns of silicon at the bottom of each pit 90 are removed until the desired layer thickness of silicon remains (e.g., between 1 and 10 microns).

To form the second membranes 16 of the micro-transducers 10, an array of square pits is machined on the back side of a second wafer (not shown), wherein the array on the second wafer corresponds to the array of pits 90 on the first wafer 88. Machining is continued on the second wafer until approximately 30 microns of silicon remains at the bottom of each pit. To form the side walls 20 of the fluid cavities 8, a layer of photoresist material such SU-8 is spin-coated on the front side of the second wafer. The cavity thickness of each micro-transducer 10, preferably about 50 microns, is defined by the thickness of the photoresist layer added to the second wafer. Photo-lithography is then used to define a pattern of squares on the photoresist material having the same foot print as the squares defining the first membranes 18 and the second membranes 16. The unmasked portions of the photoresist layer are etched to a depth of 50 microns to form the fluid cavities 8. After the cavities 8 are defined, a small amount of working fluid is added to each cavity using, e.g., a syringe dispenser. The first wafer 88 is then brought face-down into contact with the SU-8 photoresist deposited on the front side of the second wafer, with the square cavities on both wafers being in alignment with each other. Finally, the first and second wafers are secured together to form an array of identical micro-transducers. If desired, the individual transducers may be separated from the wafers for applications having power or cooling requirements that can be met using only a few transducers.

### EXAMPLE 2

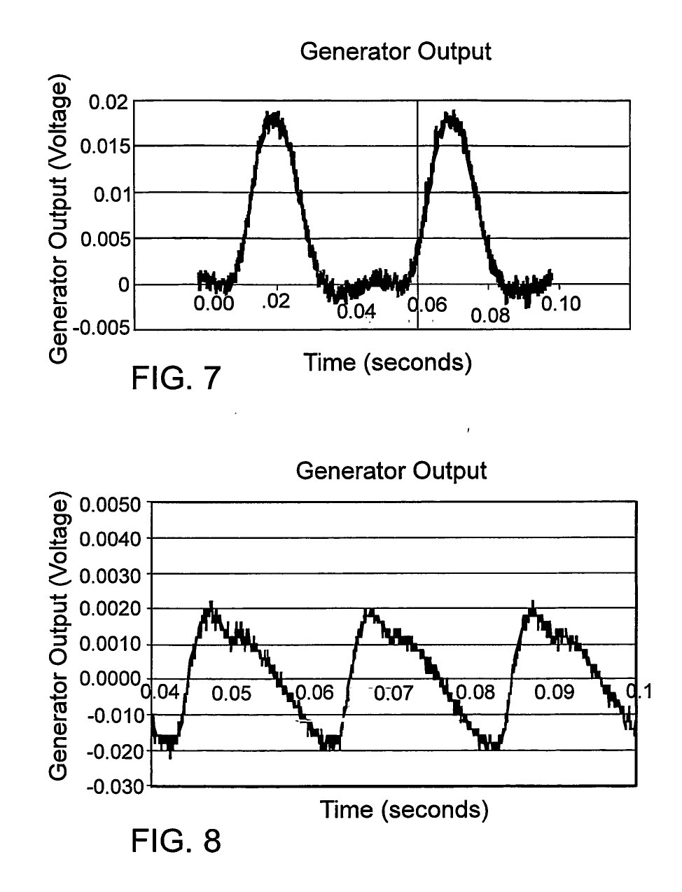

A micro-heat engine was constructed having an engine-cavity thickness of about 500 microns, a 4 mm×4 mm first membrane 16, a 3 mm×3 mm second membrane 18 having a 1-micron PZT layer, and an annular wick structure 11 formed on the inner surface of the first membrane 16. A continuous heat source was periodically thermally coupled to the first membrane 16 via a thermal switch comprising solid silicon contacts. The output voltage generated by the micro-heat engine operating at a frequency of about 20 Hz was measured, and is illustrated in the graph shown in FIG. 7.

### EXAMPLE 3

A micro-heat engine was constructed having an engine-cavity thickness of about 75 microns, a 4 mm×4 mm first membrane 16, a 4 mm×4 mm second membrane 18 having a 2-micron thick PZT layer, and an annular wick structure 11 formed on the inner surface of the first membrane 16. A continuous heat source was periodically thermally coupled to the first membrane 16 via a thermal switch comprising solid silicon contacts. The output voltage generated by the micro-heat engine operating at a frequency of about 50 Hz was measured, and is illustrated in the graph shown in FIG. 8.

### EXAMPLE 4

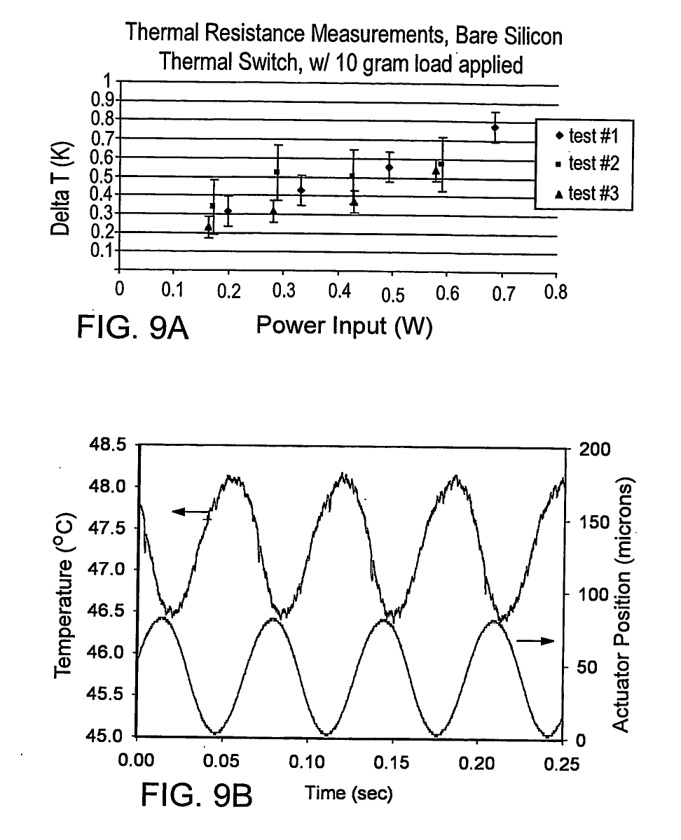

A thermal switch was constructed having two opposing silicon contacts. In one test, a variable heat source was connected to one of the silicon contacts. The contacts were pressed together under a 10-gram load and the temperature difference across the two contacts was measured. FIG. 9A shows the temperature difference measured across the switch at different thermal loads (power input) applied to the switch.

In another test, a continuous heat source was connected to one of the silicon contacts and was cyclically moved toward and away from a stationary contact at a rate of about 20 Hz, alternately closing and opening the switch. The bottom graph in FIG. 9B shows the position of the movable contact relative to the stationary contact. The top graph in FIG. 9 shows the temperature of the stationary contact as the movable contact moves toward and away from the stationary contact.

### Liquid-Droplet Thermal Switch

In the embodiments of FIGS. 3, 2A-2D, and 5, the thermal switches (e.g., thermal switches 66, 68 of FIG. 1) are depicted as solid contacts. However, other types of thermal switches can be implemented to control the flow of heat into and out of the micro-transducers previously described. One such thermal switch utilizes one or more drops of liquid to conduct heat between two surfaces.

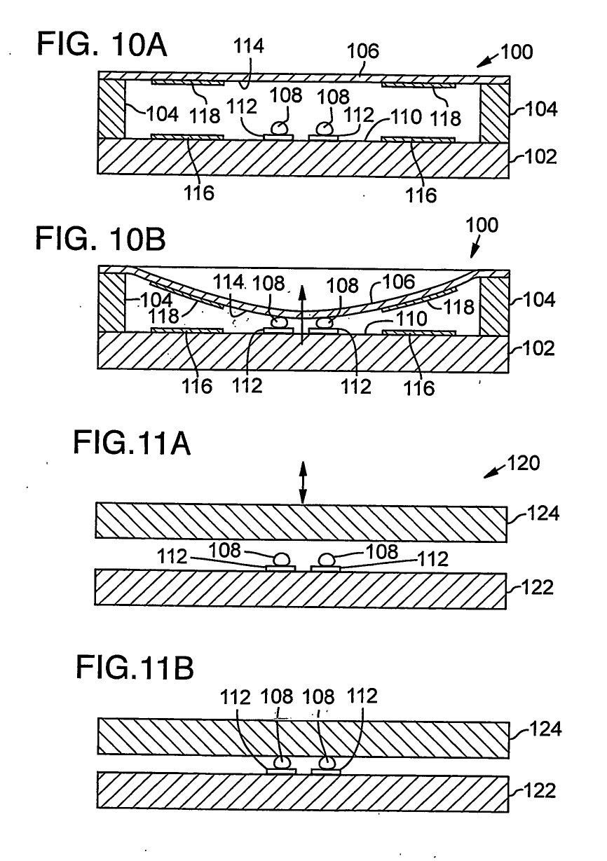

One embodiment of a liquid-droplet thermal switch is shown in FIGS. 10A and 10B. FIGS. 10A and 10B illustrate a thermal switch 100 that includes a first thermally conductive member 102, a second thermally conductive member 106, and posts, or spacers, 104 disposed between and separating the thermally conductive members 102, 106. The first thermally conductive member 102 serves as a base, or support, for carrying one or more drops 108 of a thermally conductive liquid.

In particular embodiments, the liquid drops 108 are drops of liquid metal, such as mercury, gallium, or indium, or metal alloys, such as gallium-indium alloy. As used herein, the term “metal” is used generically to refer to metals and metal alloys. Liquids other than metals which exhibit good thermal conductance also can be used.

The drops 108 may be supported on respective pads, or contacts, 112 that are also made of a thermally conductive material. The surface tension between the drops 108 and the contacts 112 retains the drops 108 on their respective contacts 112 during operation of the thermal switch.

The second thermally conductive member 106 in the illustrated embodiment is a flexible membrane (also referred to herein as a flexible member) which serves as an actuator or activation device that is selectively deflectable between a non-deflected position (shown in FIG. 10A) and a deflected position (shown in FIG. 10B). When the membrane 106 is in the deflected position (FIG. 10B), the membrane thermally contacts the liquid drops 108 to “close” the thermal switch and establish a path of low thermal resistance and high thermal conductance between the membrane and the base 102 to facilitate the flow of heat through the thermal switch. This may be referred to as the “on” or “activated” state of the thermal switch. As used herein, to bring two surfaces into “thermal contact” with each other means to bring the surfaces within sufficient proximity to each other to cause the rate of heat transfer between the surfaces to increase. “Thermal contact” may include, but is not limited to, actual physical contact between the surfaces.

When the membrane 106 is in the non-deflected position (FIG. 10A), the membrane 106 is spaced from the liquid drops 108 to “open” the thermal switch so that a path of high thermal resistance and low thermal conductance exists between the membrane 106 and the base 102. This may be referred to as the “off” or “de-activated” state of the thermal switch. Thus, the membrane 106 can be selectively activated to alternately establish a path of high thermal conductance in the on position and a path of low thermal conductance in the off position. The performance of the thermal switch 100 can be characterized by the ratio of the thermal resistance of the switch in the “on” position to the thermal resistance of the switch in the “off” position.

To maximize heat transfer through the thermal switch when it is in the “on” position, the membrane 106 desirably is configured to contact physically and thereby slightly compress the drops 108, as shown in FIG. 10B. As demonstrated in the example below, increasing the force applied to the drops 108 by the membrane 108 causes an increase in the thermal conductivity of the thermal switch.

The direction of heat flow through the thermal switch 100 depends on the application in which the thermal switch is used. For example, if the base 102 is a heat source (or is coupled to a heat source) and the membrane 106 is a heat sink (or is coupled to a heat sink), then heat flows from the base 102 to the membrane 106 (as indicated by the arrow in FIG. 10B) whenever the membrane 106 is actuated to thermally contact the liquid drops 108. Conversely, if the base 102 is a heat sink (or is coupled to a heat sink) and the membrane 106 is a heat source (or is coupled to a heat source), then heat flows from the membrane to the base whenever the membrane is actuated to thermally contact the liquid drops 108.

Any of various suitable techniques can be implemented to cause deflection of the membrane 106 and activate the thermal switch 100. In the illustrated embodiment, for example, one or more electrodes 116 are mounted to the upper surface 110 of the base 102 and one or more electrodes 118 are mounted on the lower surface 114 of the membrane 106. The electrodes 116, 118 may comprise any suitable material, such as gold, platinum, or various other metals or alloys. The electrodes 116 are electrically connected to one terminal of a power source (not shown) via respective leads (not shown), and the electrodes 118 are electrically connected to the other terminal of the power source via respective leads (not shown). When a voltage is applied to the electrodes 116, 118, an electrostatic force is generated that causes the membrane 106 to deflect inwardly toward the base 102 (FIG. 10B). Removing the voltage causes the membrane 106 to return to its non-deflected position (FIG. 10A). In this manner, the membrane 106 functions as an electrostatic transducer.

In another embodiment, the membrane 106 is a piezoelectric transducer comprising a piezoelectric member interposed between two electrodes, much like the first membrane 18 of the micro-transducer 10 depicted in FIG. 1. Such a piezoelectric transducer deflects inwardly toward the drops 108 upon application of a voltage to the electrodes. In still other embodiments, the membrane 106 can be an electromechanical transducer, a magnetic transducer, a magnetostrictive transducer, a capacitive transducer, or an equivalent device that can be deflected toward and away from the drops 108 upon application and removal of a stimulus.

In certain embodiments, the space between the membrane 106 and the base 102 is a fluid-tight cavity that contains an insulating gas having a low thermal conductivity (e.g., argon). The gas increases the thermal resistance of the thermal switch whenever the switch is in the “off” position. Alternatively, a vacuum can be established inside cavity to increase the thermal resistance of the thermal switch whenever the switch is in the “off” position.

Conventional micro-manufacturing techniques can be used to fabricate one or more identical thermal switches 100. One embodiment for forming thermal switches is as follows. First, a 100-nm layer of silicon dioxide is formed on both sides of a silicon wafer using a wet oxidation process. A 5-nm layer of titanium/tungsten and a 325-nm layer of gold are then sputtered on both sides of the wafer. Using conventional photolithography, a pattern of 10 mm×18 mm rectangular dies is formed on the front surface of the wafer, and a grid of 30-μm gold contacts 112 is formed at the center of each die. In addition, a pattern of interwoven 30-Ω resistance heaters and resistance-based temperature detectors (RTDs) is formed on the back surface of the wafer such that a resistance heater and an RTD is located opposite a respective grid of gold contacts. After developing the photoresist on both sides of the wafer, the gold and titanium layers are chemically etched from the unprotected regions of the wafer surfaces so that only the contacts, the RTDs and the heater remain on the wafer surfaces. The wafer is then diced into individual die to form bases 102.

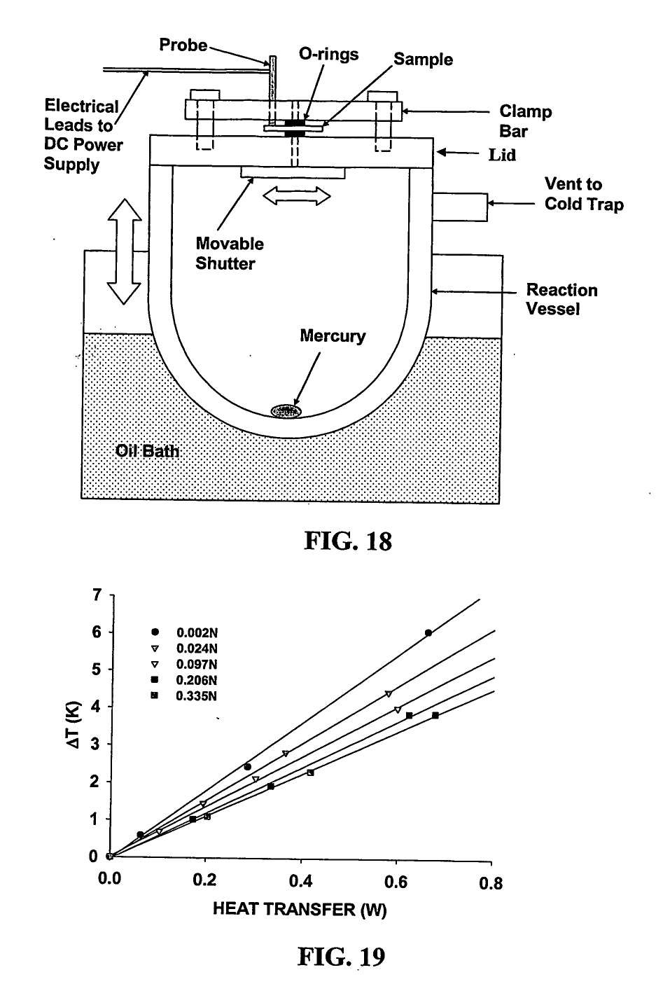

A deposition chamber be used form drops 108 on the contacts 112 of each die. FIG. 18 schematically illustrates one example of a deposition chamber that can be used to form the drops 108. The illustrated deposition chamber comprises a 500-mL glass reaction vessel and a PTFE lid, which are sealed together with a jar clamp. The heat-conducting liquid for forming the drops (in this case mercury) is placed in the vessel. The vessel is placed in an oil bath to vaporize the mercury. A die is positioned face down over a 3-mm diameter hole formed in the lid so that the contacts 112 are exposed to mercury vapor via the hole. A clamping bar secures the die to the lid and an o-ring seals the die to the top of the lid. The exposure of mercury to the die is controlled by a movable glass slide, which can be actuated magnetically. Gold probes are electrically connected to a DC power supply and the resistance heater on the back surface of the die. A hot plate (not shown) is used to heat the oil bath, which evaporates the mercury. A vent in the vessel, which is in communication with a cold trap, prevents over-pressurization in the vessel.

To perform mercury deposition, and according to one specific approach, the power supply is set to provide a constant voltage of about 3.3 V and a current of about 0.11 A to the resistance heater to achieve a surface temperature of about 50° C. on the die. The temperature of the oil bath, which is maintained at about 180° C., is increased until the vapor pressure of the mercury in the vessel is increased to about 1.5 kPa. After heating the vessel for about 30 minutes, the slide is opened to expose the gold contacts on the die to mercury vapor. The mercury vapor chemically reacts with the gold contacts, which results in preferential condensation of liquid droplets on the contacts. The total exposure time of the contacts to the mercury vapor governs the size of the droplets. For example, exposing the contacts to mercury vapor for about 3 hours will form droplets that are approximately 30 μm in diameter. The deposition process is completed by closing the slide and heating the die with the power supply for an additional 15 minutes to allow mercury trapped in the hole in the lid to deposit on the contacts.

Plural membranes 106 having spacers 104 can be fabricated from another silicon wafer using conventional techniques. The spacers 104 can be formed by applying a layer of photoresist, PMMA (polymethyl methacrylate), or equivalent material on the wafer and then selectively etching the material in the desired shape and size of the spacers. The wafer is diced into individual membranes having spacers, which are then secured to respective dies to form a batch of thermal switches.

In another embodiment, a thermal switch can have the same configuration as the thermal switch 100 shown in FIGS. 10A and 10B, except that the drops 108 are eliminated. In such an embodiment, the membrane 106 contacts the contacts 112 (or the upper surface 110 of the base 102 if contacts 112 are not provided) whenever the switch is activated.

FIGS. 11A and 11B show a thermal switch 120 according to another embodiment. The thermal switch 120 includes first and second thermally conductive members 122 and 124, respectively, positioned in a juxtaposed relationship relative to each other. One or more liquid drops 108 are carried by the first thermally conductive member 122 and positioned for thermally contacting the second thermally conductive member 124. Each drop 108 may be supported on a respective contact 112.

FIG. 11A shows the thermal switch 120 in the “off” position, in which a path of high thermal resistance exists between the thermally conductive members 122, 124. To activate the thermal switch 120, the spacing between the thermally conductive members 122, 124 is decreased to establish a path of low thermal resistance between the thermally conductive members. Desirably, the second thermally conductive member 124 physically contacts the drops 108 whenever the thermal switch is activated, as shown in FIG. 11B.

The spacing between the thermally conductive members 122, 124 can be varied by moving one or both of the thermally conductive members toward and away from each other. Movement of one or both of the thermally conductive members 122, 124 can be accomplished in any suitable manner. In one implementation, for example, one or both of the thermally conductive members can be coupled to the piston of a respective solenoid or equivalent device.

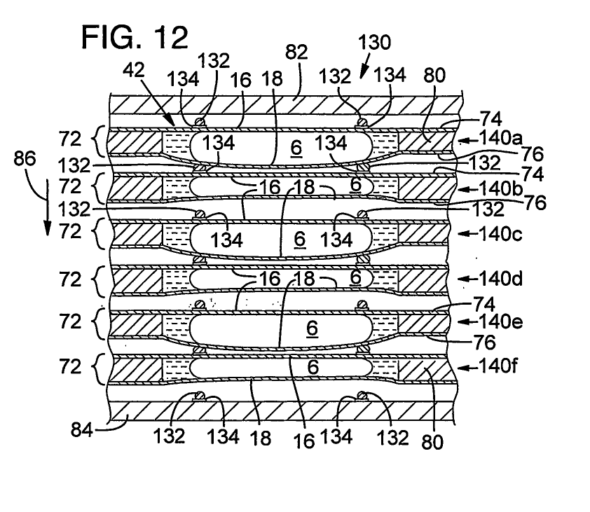

A specific application of a thermal switch having one or more thermally conductive liquid droplets is shown in FIG. 12. FIG. 12 shows an energy-conversion apparatus, indicated at 130, that is similar in construction to the apparatus 70 shown in FIG. 5. Thus, components in FIG. 12 that are identical to corresponding components in FIG. 5 have the same respective reference numerals.

As shown in FIG. 12, the apparatus 130 comprises pairs 72 of first and second substrates 74, 76, respectively, (e.g., pairs of silicon wafers) stacked superposedly with respect to each other so as to form a system of cascading levels 140a, 140b, 140c, 140d, 140e, and 140f. Each level 140a-140f operates over its own respective temperature differential. An array of identical heat engines 42 is formed from the first and second substrates 74 and 76, respectively, in each level 140a-140f (although only one heat engine of each level is shown in FIG. 12). A high-temperature heat source 82 is positioned adjacent to the heat engines 42 of level 140a, and a low-temperature heat sink 84 is positioned adjacent to the heat engines 42 of level 140f. Thus, level 140a operates in the highest temperature range of the cascade, and level 140f operates in the lowest temperature range of the cascade.

Thermal switches comprising one or more thermally conductive liquid droplets 132 are disposed on the second membranes 16 of the heat engines 42 and on the low-temperature heat sink 84. Each liquid droplet 132 can be disposed on a respective pad or contact 134. In particular embodiments, the droplets 132 have a diameter of about 10 to 1000 microns, with 30 microns being a specific example, although larger or smaller droplets can be used depending on the application. The liquid droplets 132 control the flow of heat into and away from each heat engine 42 by facilitating the transfer of heat into a heat engine during the heat-addition process and by facilitating the transfer of heat out of a heat engine during the heat-rejection process.

Apparatus 130 can be operated in the same manner as apparatus 70 of FIG. 5. In one implementation, for example, the apparatus 130 is operated such that each heat engine 42 of a particular level undergoes the same portion of the thermodynamic cycle at the same time, but 180° out of phase from an adjacent level. In addition, the high-temperature heat source 82 is operated periodically to contact the droplets 132 supported on the heat engines 42 of level 140a in a thermal manner.

More specifically, and referring to FIG. 12, the heat engines 42 of levels 140a, 140c, and 140e are shown as completing the expansion process and beginning the heat-rejection process, while the heat engines 42 of levels 140b, 140d, and 140f are shown as completing the compression process and beginning the heat-addition process. As shown, the membranes 18 of the heat engines in levels 140a, 140c, and 140e are flexed outwardly and contact the droplets 132 supported on the heat engines of levels 140b, 140d, and 140f. This causes heat to be rejected by the heat engines of levels 140a, 140c, and 140e and absorbed by the heat engines of levels 140b, 140d, and 140f. In addition, heat does not flow into the heat engines of level 140a at this stage of the thermodynamic cycle because the heat source 82 is not in thermal contact with the droplets 132 supported on the heat engines of level 140a.

As the thermodynamic cycle continues, the membranes 18 of the heat engines in levels 140b, 140d, and 140f flex outwardly and contact the droplets 132 supported on the heat engines of levels 140c, 140e, and the heat sink 84, and the heat source 82 contacts the droplets 132 supported on the heat engines of level 140a. This causes heat to flow into the heat engines of levels 140a, 140c, and 140e, and heat to be rejected by the heat engines of levels 140b, 140d, and 140f.

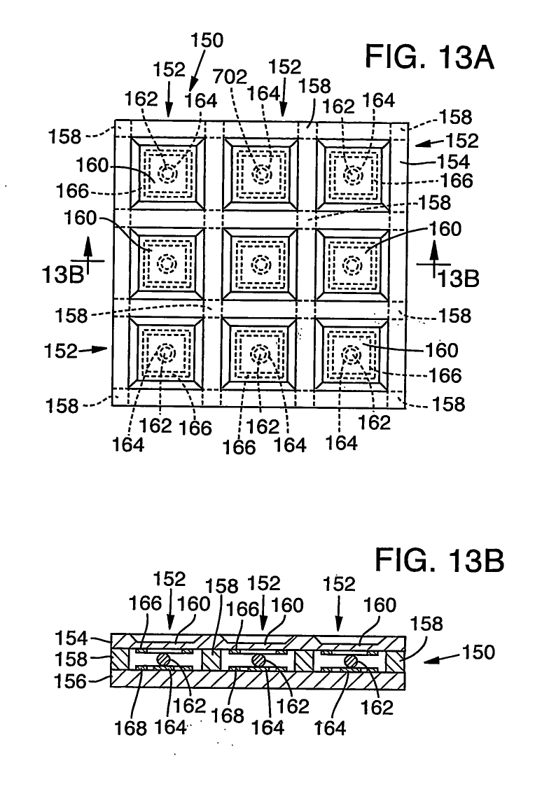

Referring to FIGS. 13A and 13B, there is shown an embodiment of thermal-switch assembly 150 comprising a 3×3 array of independently operable thermal switches 152. As best shown in FIG. 13B, the thermal switches 152 are formed from a first substrate 154 and a second substrate 156 maintained in a spaced relationship relative to each other by spacers 158. The first substrate 154 is formed with a 3×3 array of recessed portions 160, which serve as flexible membranes for the thermal switches 152. Each thermal switch 152 has at least one thermally conductive liquid droplet 162 disposed on the second substrate and positioned to thermally contact a respective membrane 160. As shown, each droplet 162 can be disposed on a respective contact 164. As shown in FIG. 13A, each droplet 162 desirably is centrally disposed in its respective thermal switch 152 to maximize contact between the membranes 160 and the droplets 162 whenever individual switches are activated.

Each membrane 160 functions as an actuator that is selectively deflectable between a non-deflected position (shown in FIG. 13B) and a deflected position (not shown in the drawings) to thermally contact a respective liquid droplet 162. Any suitable techniques can be implemented to cause deflection of the membranes. In the illustrated embodiment, for example, each thermal switch 152 has at least one electrode 166 mounted on its respective membrane 160 and at least one electrode 168 mounted on the substrate 156. The electrodes 166 are electrically connected to one of the terminals of a power source (not shown) via respective leads (not shown), and the electrodes 168 are electrically connected to the opposite terminal of the power source via respective leads (not shown). When a voltage is applied to the electrodes 166, 168 of a thermal switch 152, the generated electrostatic charge causes its membrane 160 to deflect inwardly and contact the droplet 162. In alternative embodiments, the membranes 160 can be any of various transducers that are operable to deflect upon application of a stimulus (e.g., an applied voltage).

In addition, the membranes 160 can be activated independently of the each other to allow for selective activation of the thermal switches 152. A thermal switch 152 that is activated or turned “on” establishes a path of high thermal conductance between the first and second substrates 154, 156 at that portion of the assembly. Conversely, a path of low thermal conductance exists at each thermal switch 152 is that “off”. By selectively activating and de-activating individual thermal switches 152, the thermal conductivity of the assembly 150 can be varied spatially and temporally. In this regard, the assembly 150 exhibits a “digital” thermal conductivity that can be controlled by the selective activation of individual thermal switches 152.

Although the illustrated embodiment comprises a 3×3 array of thermal switches, it will be appreciated that the assembly can be modified as desired to include any number of thermal switches. In addition, each thermal switch 152 has a generally rectangular shape, although in other embodiments they can be circular or any of various other shapes. The substrates 154, 156 can comprise any of various suitable materials, such as silicon, quartz, sapphire, ceramic, or any of various metals or alloys.

In one specific application, the assembly 150 can be used to control the removal of heat from integrated circuits on a substrate. For example, the assembly 150 can be coupled to the substrate so that each thermal switch 152 is registered with a respective integrated circuit. In use, each thermal switch 152 is normally in the “off” position (i.e., the membranes 160 are not in thermal contact with droplets 162) so that substantially no heat is removed from any of the integrated circuits. When the temperature of an integrated circuit exceeds a predetermined threshold, the corresponding thermal switch 152 is activated to allow heat to be removed from the integrated circuit through the activated thermal switch. After the temperature of the integrated circuit drops below an acceptable level, the thermal switch is de-activated to avoid unnecessary further cooling of the circuit

In another application, the assembly 150 can be used to control the flow of heat from a heat source into a device, such as the apparatus 130 shown in FIG. 12. For example, the assembly 150 can be positioned between the heat source 82 and the adjacent level of heat engines 42 so that each thermal switch 152 is registered with a corresponding heat engine 42. Thus, in this embodiment, the assembly 152 essentially replaces the droplets 132 and corresponding contacts 134 supported on the uppermost level of heat engines. In use, the thermal switches 152 are operated to control the flow of heat from the heat source into the stacks of heat engines. If a thermal switch is activated, then heat is allowed to flow from the heat source 82 to the uppermost heat engine of the corresponding stack of heat engines, which converts the heat energy into electrical energy as previously described.

In an alternative embodiment, a thermal-switch assembly has a construction that is similar to the construction of assembly 150, except that each thermal switch defines a fluid-tight cavity between the first and second substrates 154, 156, respectively. The fluid-tight cavities can be formed by positioning between the first and second substrates an intermediate layer of material having an array of apertures that define the side walls of the cavities. The cavities can contain an insulating gas having a low thermal conductivity (e.g., argon) to increase the thermal resistance of the switches whenever they are de-activated. Alternatively, a vacuum can be established inside cavity to increase the thermal resistance of the thermal switch whenever the switch is in the “off” position.

In another embodiment, a thermal-switch assembly has a construction that is similar to the construction of assembly 150, except that each thermal switch 152 has a solid contact instead of a liquid droplet 162. Each contact is dimensioned to contact the inner surface of a membrane 160 whenever the thermal switch is activated. The contacts can be made of silicon or any of various other materials exhibiting good thermal conductivity. In one implementation, the membranes 160 are made of silicon and a silicon contact is formed on the substrate 156 opposite each membrane 160.

The assembly 150 can be made using conventional micro-manufacturing techniques. In one embodiment for making the assembly 150, for example, the first and second substrates 154, 156 are formed from first and second silicon wafers, respectively.

The first substrate 154 is prepared by forming an oxide layer on both sides of the first wafer. Using conventional photolithography, a 3×3 array is patterned on the back surface of the first wafer (the surface facing upwardly in FIG. 13B). The first wafer is then placed in an anisotropic etchant until a 3×3 array of 2-μm thick boron-doped membranes are formed. Conventional photolithography is then used to pattern a 3×3 array of gold electrodes 166 and corresponding leads on the front surface of the first wafer (the surface facing downwardly in FIG. 13B). A layer of 10-μm thick PMMA (polymethyl methacrylate) or equivalent material is spun onto the front surface of the first wafer then selectively etched to form a 4×4 array of 100-μm spacers 158.

The second substrate 156 is prepared by forming an oxide layer on both sides of the second wafer. Using conventional photolithography, a 3×3 array of gold electrodes and corresponding leads are formed on the front surface of the second wafer (the surface facing downwardly in FIG. 13B). A 3×3 array of gold contacts 164 and 30-μm diameter mercury droplets 162 are formed on the back surface of the second wafer in accordance with the process discussed above in connection with the embodiment of FIGS. 10A and 10B. The back surface of the second wafer is then secured to the spacers 158 formed on the front surface of the first wafer to form the assembly shown in FIGS. 13A and 13B.

### Thermoelectric Cooler

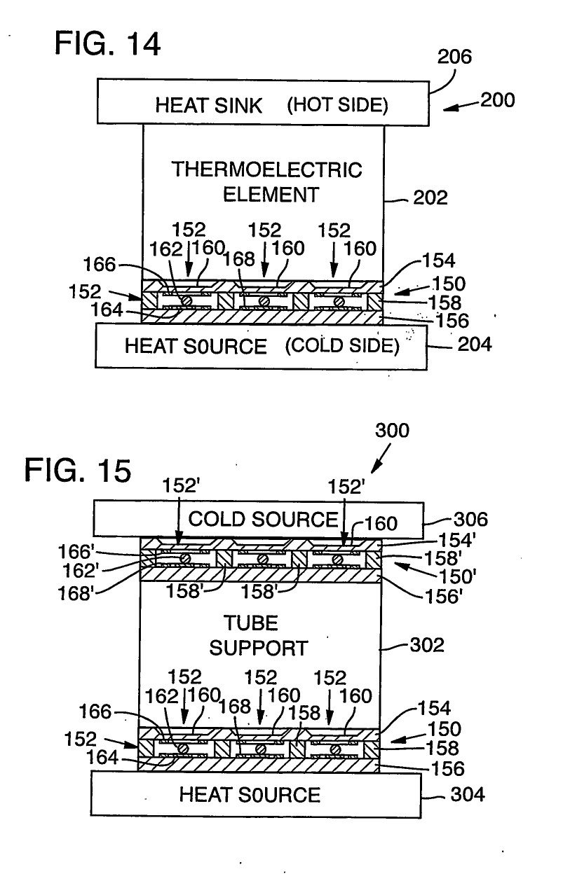

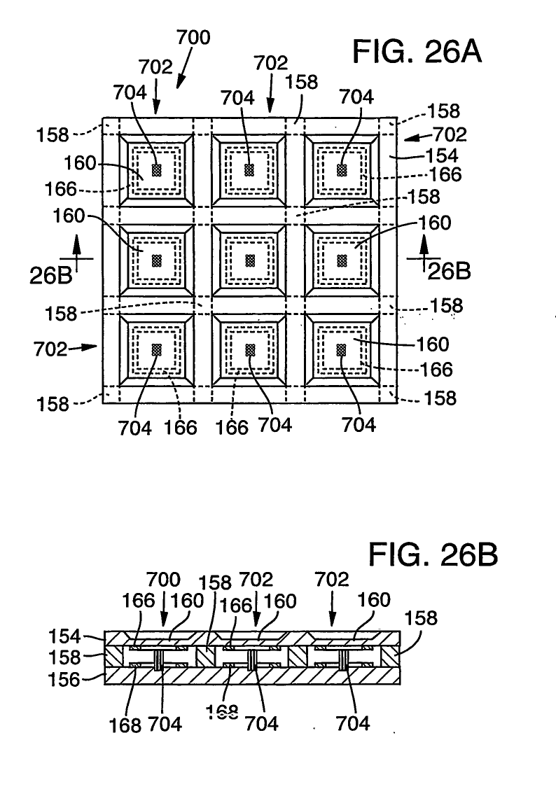

Referring now to FIG. 14, there is shown an improved thermoelectric cooler 200 that incorporates the thermal-switch assembly 150 of FIGS. 13A and 13B. The thermoelectric cooler 200 includes a thermoelectric element 202, which may comprise an N-type thermoelectric element and a P-type thermoelectric element, as known in the art. A low-temperature heat source 204 is cooled and a high-temperature heat sink 206 is heated by the thermoelectric element 202. In the illustrated embodiment, one end of the thermoelectric element 202 is continuously thermally coupled to the heat sink 206 through a path of low thermal resistance. The opposite end of the thermoelectric element 202 is thermally coupled to the heat source 204 through the thermal-switch assembly 150, which can include any number.of thermal switches 152. In other embodiments, the thermal-switch assembly 150 can be replaced with other thermal switch configurations disclosed herein (e.g., the thermal switch 120 of FIGS. 11A and 11B or the thermal-switch assembly 700 of FIGS. 26A and 26B).

In use, the thermal switches 152 are activated to establish a path of low thermal resistance between the heat source 204 and the thermoelectric element 202. A power source (not shown) provides a voltage across the thermoelectric element 202 to produce an electric current, as known in the art. During the flow of current, the thermoelectric element 202 absorbs heat from the heat source 204 and rejects heat to the heat sink 206. This phenomenon is known as the Peltier effect. The net cooling caused by the Peltier effect is offset by Joule heating caused by the electrical resistance of the thermoelectric element 202.

To minimize the effects of Joule heating, and therefore to increase the efficiency of the thermoelectric cooler 202, a current pulse is applied to the thermoelectric element 202. The power supply can be used to create the pulsed current or, alternatively, an electrical switch can be placed in series with the power source to provide-a pulsed current. Each current pulse causes instantaneous cooling of the heat source 204 and heating of the heat source 204. Immediately after each current pulse, the thermal-switch assembly 150 is opened by de-activating the switches 152 to prevent heat from Joule heating from being transferred to the heat source 204. After the thermal-switch assembly 150 is opened, any residual thermal energy in the thermoelectric element 202 due to Joule heating flows to the heat sink 206. When the temperature of the thermoelectric element 202 drops to an acceptable level, the thermal switch assembly 150 is closed by activating the switches 152 and another current pulse is supplied to the thermoelectric element 202. This process is repeated until further cooling is not required.

### Thermal Cycler

Referring now to FIG. 15, there is shown an improved thermal cycler 300 that can be used for heating and/or cooling biological or chemical samples in laboratory analysis. For example, in DNA-amplification methods, such as PCR (polymerase chain reaction) and NASBA (nucleic acid sequence based amplification), thermal cyclers are used for cyclically heating and cooling DNA samples.

The illustrated thermal cycler 300 includes a tube support 302 that is configured to support one or more tubes or containers (commonly referred to as Eppendorf® tubes or micro-tubes) containing a biological or chemical sample (e.g., a DNA sample) to be processed by the thermal cycler. The tube support 302 can be, for example, a block or plate having an array of wells or openings (e.g., a 12×8 array) dimensioned to receive respective tubes, as known in the art. Each tube of the tube support 302 is thermally coupled to a heat source 304 through a thermal switch assembly 150 and to a cold source 306 through a thermal switch assembly 150′. In lieu of thermal-switch assemblies 150, 150′, the thermal cycler may incorporate other thermal-switch configurations disclosed herein to thermally couple the heat source 304 and the cold source 306 to the tubes.

The thermal-switch assemblies 150, 150′ control the flow of heat and cold to the tubes during operation of the thermal cycler 300. For example, to heat the samples contained in the tubes, the thermal switches 152 of the thermal-switch assembly 150 are closed and the thermal switches 152′ of the thermal-switch assembly 150′ are opened. This allows heat to be transferred from the heat source 304 to the samples contained in the tubes. To cool the samples contained in the micro-tubes, the thermal switches 152 of the thermal-switch assembly 150 are opened and the thermal switches 152′ of the thermal-switch assembly 150′ are closed to allow heat to flow from the samples to the cold source 306.

In particular embodiments, the thermal-switch assemblies 150, 150′ can have respective arrays of thermal switches 152, 152′ that correspond to the array of micro-tubes of the tube support 302. Each thermal switch 152 is operable to couple a respective tube thermally to the heat source 304, and each thermal switch 152′ is operable to couple a respective tube thermally to the cold source 306. Since the thermal switches 152, 152′ can be actuated independently of each other, the temperature of individual tubes can be independently controlled. Advantageously, the process parameters (e.g., start time and temperature pattern) for each tube can be varied. For example, if multiple tubes (e.g., 96 tubes) are to be processed using the thermal cycler 300, it is not necessary to delay processing until the sample in each and every tube has been prepared for processing by the thermal cycler.

### EXAMPLE 5

In this example, the performance of two mercury-droplet thermal switches is illustrated. One thermal switch comprised a 10 mm×18 mm silicon die having a 20×20 array of 30-μm mercury droplets (referred to as the 400-droplet thermal switch). Another silicon die without droplets formed the opposite side of the thermal switch. The other thermal switch comprised a 10 mm×18 mm silicon die having a 40×40 array of 30-μm mercury droplets and another silicon die without droplets (referred to as the 1600-droplet thermal switch). The silicon dies were formed using the fabrication techniques previously described.

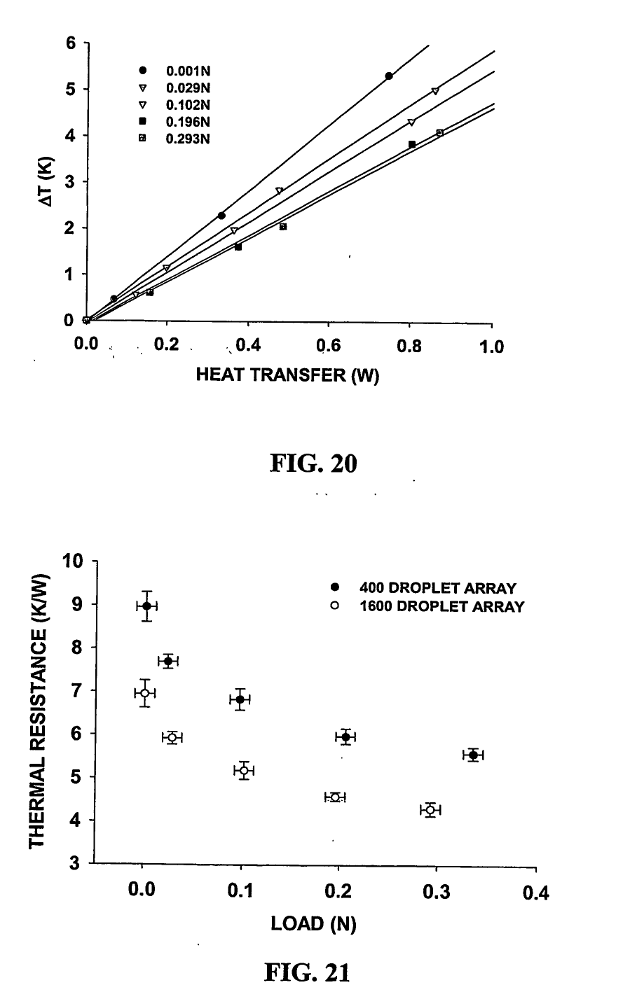

FIG. 19 shows the steady-state heat transfer across the 400-droplet thermal switch under different applied loads (i.e., the force compressing the droplets between the two silicon dies). In FIG. 19, the temperature difference across the switch is plotted against the heat transferred across the array of droplets. Each line corresponds to a different load applied to the thermal switch. The slopes of the lines are equivalent to the thermal resistances of the thermal switch. As shown, as the compressive load on the thermal switch increases, the thermal resistance across the thermal switch decreases, thereby increasing the rate at which heat can be transferred across the thermal switch. FIG. 20 shows a similar plot for the 1600-droplet thermal switch.

The dependence of the thermal resistance of each thermal switch on applied load is illustrated in FIG. 21. The thermal resistance at each load is the average thermal resistance of the data points that lie on the line in either FIG. 19 or FIG. 20 corresponding to the load. As shown in FIG. 21, the thermal resistance of the 400-droplet switch falls from 9 K/W to 6 K/W as the load increases from 0 to 0.34 N. The thermal resistance of the 1600-droplet switch falls from 7 K/W to 4.5 K/W as the load increases from 0 to 0.29 N. The thermal resistance of each switch changes by a factor of about 1.5 as the droplets undergo deformation from zero load to a load of about 0.4 N. The same relative change in thermal resistance is seen for both array sizes. The 400-droplet switch has a higher thermal resistance than the 1600-droplet switch. This higher resistance is likely the result of fewer mercury conduction paths across the switch.

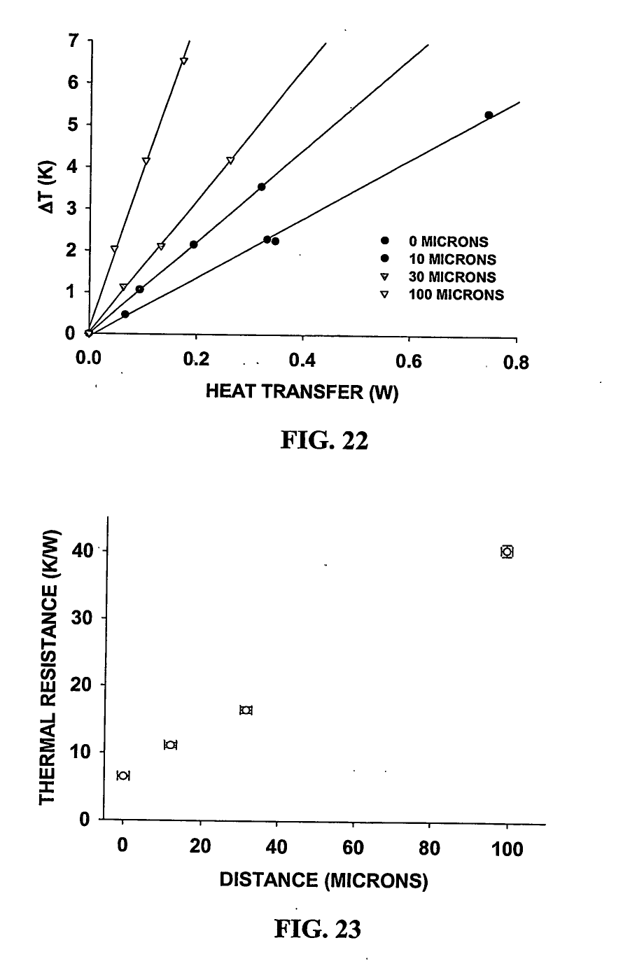

FIG. 22 shows the heat transfer across the 1600-droplet switch for different air-gap distances between the droplets and the silicon die without droplets. As shown in FIG. 22, the thermal resistance of the switch increases as the spacing between the die and the droplets is increased. FIG. 23 is a plot of the average thermal resistances for the air-gap distances shown in FIG. 22. The plot of FIG. 23 indicates that the thermal resistance of the switch increases linearly as the spacing is increased.

The change in thermal resistance between “on” and “off” states of the 1600-droplet switch can be determined by comparing FIGS. 21 and 23. For example, as indicated in FIG. 21, the thermal resistance of the thermal switch when the droplets are fully deformed (corresponding to the 0.3-N load) is about 4.5 K/W. As indicated in FIG. 23, the thermal resistance of the thermal switch having a 100-micron spacing between the droplets and the heater die is about 40 K/W. Thus, operating the switch between these two positions causes the thermal resistance of the switch to increase or decrease by about a factor of nine whenever the switch is opened or closed, respectively.

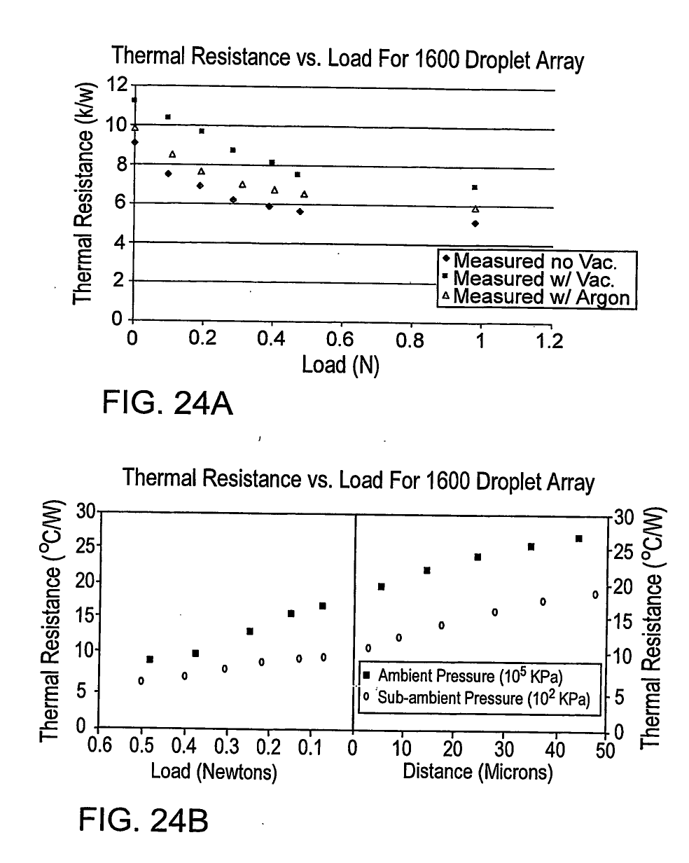

FIG. 24A is a plot of the thermal resistance of a 1600-droplet thermal switch as a function of applied load when operated at atmospheric pressure, a plot of the thermal resistance when a vacuum is established inside the switch (between the two silicon dies), and a plot of the thermal resistance when argon gas is contained inside the switch. As shown, the thermal resistance of the switch increases whenever the argon gas is contained in the switch and whenever a vacuum is established inside the switch, with the latter situation providing the greatest increase in thermal resistance.

FIG. 24B is a plot of the thermal resistance of a 1600-droplet thermal switch as a function of applied load and gap distances when operated at atmospheric pressure and a plot of the thermal resistance exhibited by the switch whenever a vacuum is established inside the. switch.

### “Heat-Pipe” Thermal Switch

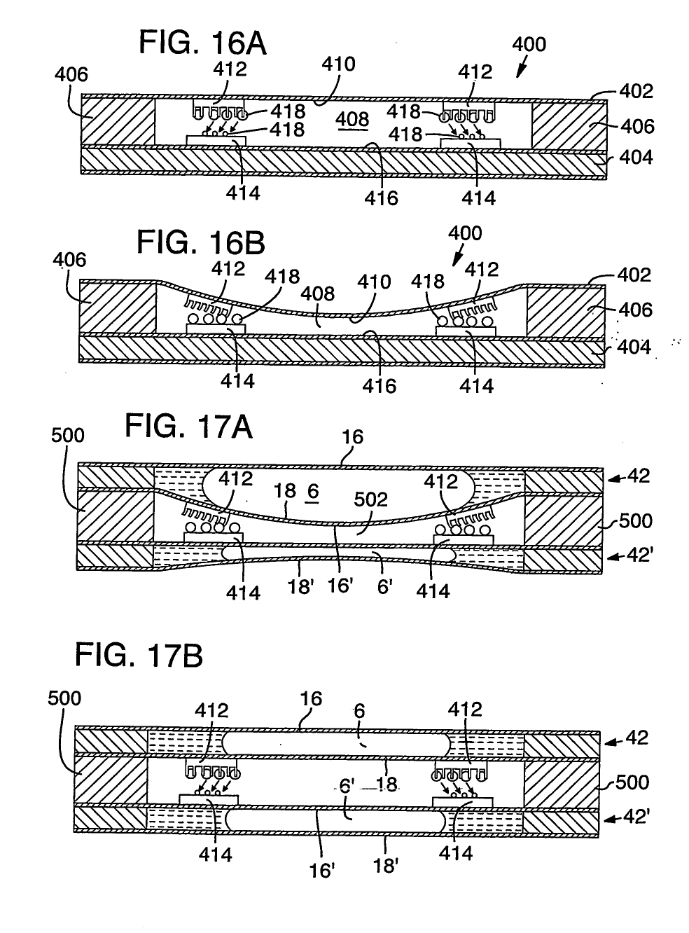

Referring to FIGS. 16A and 16B, there is shown a thermal switch 400, according to another embodiment, that functions in a manner similar to a conventional heat pipe. The thermal switch 400 in this embodiment comprises a flexible membrane or member 402, a base 404 (which can be flexible or non-flexible), and a continuous wall 406 extending along the peripheral portions of the membrane 402 and the base 404 so as to define a fluid-tight cavity 408. The membrane 402 and the base 404 desirably are made of a material exhibiting good thermal conductivity.

The membrane 402 is operable to deflect between a non-deflected position (FIG. 16A) and a deflected position (FIG. 16B). The membrane 402 can be any of various transducers that deflect in response to an applied stimulus, as discussed above. Mounted to the inner surface 410 of the membrane 402 are one or more wicks 412 that are desirably made from a hydrophilic material, such as a photoresist material or an electroplated metal. Heat-transfer contacts 414 can be mounted to the inner surface 416 of the base 404 opposite the wicks 412. The heat-transfer contacts 414 desirably are made from a hydrophobic material, such as a self-assembled monolayer (SAM) of material.

Each of the wicks 412 can be a grooved structure formed on the inner surface 410 of the membrane 404. In one embodiment, for example, each wick 412 comprises a series of concentric grooves etched into a layer of material (e.g., photoresist) formed on the inner surface 410 of the membrane 402.

A working fluid 418 contained in the cavity 408 transports heat from the membrane 402 to the base 404 via the latent heat of the fluid, in a manner similar to the working fluid of a conventional heat pipe. The working fluid 418 can be any of various fluids commonly used in conventional heat pipes. For example, in relatively low-temperature applications (i.e., less than 200° F.), refrigerants such as R11 can be used. In moderate-temperature applications (i.e., above 200° F.), water may be used as the working fluid.

During operation, heat is transferred away from the membrane 402 by the evaporation of the liquid component of the working fluid 418 suspended on the wicks 412. The temperature difference between the membrane 402 and the base 404 creates a vapor pressure difference in the cavity 408, which forces the hot vapor to flow toward the heat-transfer contacts 414 where the vapor condenses (as indicated by the arrows in FIG. 16A). While condensing, heat contained in the vapor passes to the base 404. A heat sink (not shown) can be placed is thermal contact with the base 404 to conduct heat away from the thermal switch 400. Heat transfer between the membrane 402 and the base 404 ceases when all of the liquid suspended on the wicks 412 has evaporated, at which time the thermal switch 400 turns “off”.

After a predetermined time period, the membrane 402 is activated to deflect inwardly toward the base 404 (FIG. 16B) to cause the wicks 412 to contact the liquid that has condensed on the heat-transfer contacts 414. Surface tension causes the liquid to adhere to the wicks 412. The membrane 410 is then allowed to return to its non-deflected position, which carries the liquid away from the heat-transfer contacts 414 on the base 404. This cycle is then repeated to continue the transfer of heat from the membrane 402 to the base 404.

A specific application of the thermal switch 400 is shown in FIGS. 17A and 17B. FIGS. 17A and 17B depict two heat engines 42, 42′ arranged in a cascade configuration. A description of the construction and operation of heat engines 42, 42′ is given above and therefore is not repeated here. This embodiment differs from previous embodiments in that a thermal switch similar to the thermal switch 400 of FIGS. 16A and 16B is implemented in the instant embodiment to facilitate the transfer of heat between the heat engines.

As shown in FIGS. 17A and 17B, a continuous wall 500 is disposed between the peripheral portions of the heat engines 42, 42′ to form a fluid-tight cavity 502. Wicks 412 are mounted on the lower surface of the membrane 18 of the heat engine 42. Heat-transfer contacts 414 are mounted opposite the wicks 412 on the upper surface of the membrane 16′ of the heat engine 42′. A working fluid 418 is contained in the cavity 502. A thermal switch is therefore defined by the membrane 18, the membrane 16′, the wall 500, the wicks 412, the contacts 414, and the working fluid 418.

For purposes of discussion, the heat engine 42 operates over a higher temperature range than the heat engine 42′ so that heat is transferred from the heat engine 42 to the heat engine 42′. The high-temperature side of the heat engine 42 (i.e., membrane 16) is thermally coupled to a high-temperature heat source or to the low-temperature side of another heat engine operating over a higher temperature range. The low-temperature side of the heat engine 42′ (i.e., membrane 18′) is thermally coupled to a low-temperature heat sink or to the high-temperature side of another heat engine operating over a lower temperature range.

During operation, the working fluid 418 transfers heat from the heat engine 42 to the heat engine 42′. More specifically, referring initially to FIG. 17A, the heat engine 42 is depicted as completing the expansion process and beginning the heat-rejection process, while heat engine 42′ is depicted as completing the compression process and beginning the heat-addition process. At the instance shown in FIG. 17A, the membrane 18 is deflected outwardly so that the wicks 412 can contact liquid that has condensed on the heat-transfer contacts 414. Surface tension causes liquid to wick onto the wicks 412 so that, as the membrane 18 returns to its non-deflected position (FIG. 17B), liquid is carried away from the heat-transfer contacts 414. Liquid on the wicks 412 absorbs heat from the heat engine 42 and vaporizes. The vapor-pressure difference in the cavity 502 forces the vapor to flow to the heat-transfer contacts 414, at which the vapor condenses and gives up latent heat to the heat engine 42′. Heat transfer from the heat engine 42 to the heat engine 42′ continues until all of the liquid carried by the wicks 412 has evaporated. The heat engine 42 undergoes another heat-rejection process and the heat engine 42′ undergoes another heat-addition process when the membrane 18 deflects outwardly to cause wicking of condensed liquid onto the wicks 412.

### EXAMPLE 6

In an example of the cascade shown in FIGS. 17A and 17B, the heat engines 42, 42′ have the same construction and dimensions as the heat engine described above in Example 1. Photoresist or equivalent material is used to form the wall 406 between the heat engines 42, 42′. The cavity 408 contains about 2 μg of R11 refrigerant, which is sufficient to transfer about 400 μJ of thermal energy from the heat engine 42 to the heat engine 42′ in a single thermodynamic cycle. Each wick 412 comprises a layer of photoresist material having a diameter of about 300 μm. Each layer of photoresist material is formed with series of concentric grooves etched to a depth of about 2 μm.

### Thermal Switch Employing Nanostructure

Another embodiment of a thermal switch utilizes a nanostructure, such as a bundle of aligned carbon nanotubes, to establish a path of high thermal conductance between a heat source and a heat sink. Carbon nanotubes are known structures, and are essentially chains of carbon atoms forming a generally tubular structure that is typically about one-nanometer wide. Carbon nanotubes can have a single cylindrical wall or multiple cylindrical walls.

Carbon nanotubes are particularly useful for a thermal switch because they are highly conductive of heat along their longitudinal axes. However, other types of nanoscale structures, such as nanocoils (also called nanosprings), nanowires, or nanobelts, also can be used. The nanoscale structures also can be formed from materials other than carbon, such as zinc oxide, silicon oxide, tungsten oxide, cadmium sulfide, silicon carbide, or various combinations thereof For example, nanotubes can be any type of nanoscale tubular materials, such as carbon nanotubes, silicon carbide nanotubes, tungsten sulfide nanotubes and other inorganic nanotubes.

In one aspect, a thermal switch includes a nanostructure that links a heat source to a heat sink to facilitate the flow of heat therebetween. As used herein, the term “nanostructure” refers to any nanoscale structure, including, but not limited to, nanotubes, nanocoils, nanowires, or nanobelts, synthesized from carbon or other material as noted above. A nanostructure can be a single-walled structure, a multi-walled structure, or a bundle of multiple nanoscale structures. A bundle can include multiple nanostructures embedded in a matrix. Various types of carbon nanostructures and methods of synthesizing nanostructures are described by Terrones, “Science and Technology of the Twenty-First Century: Synthesis, Properties and Applications of Carbon Nanotubes,” Annual Review of Materials Research, 33:419-501 (2003) (“Terrones”), which is incorporated herein by reference.

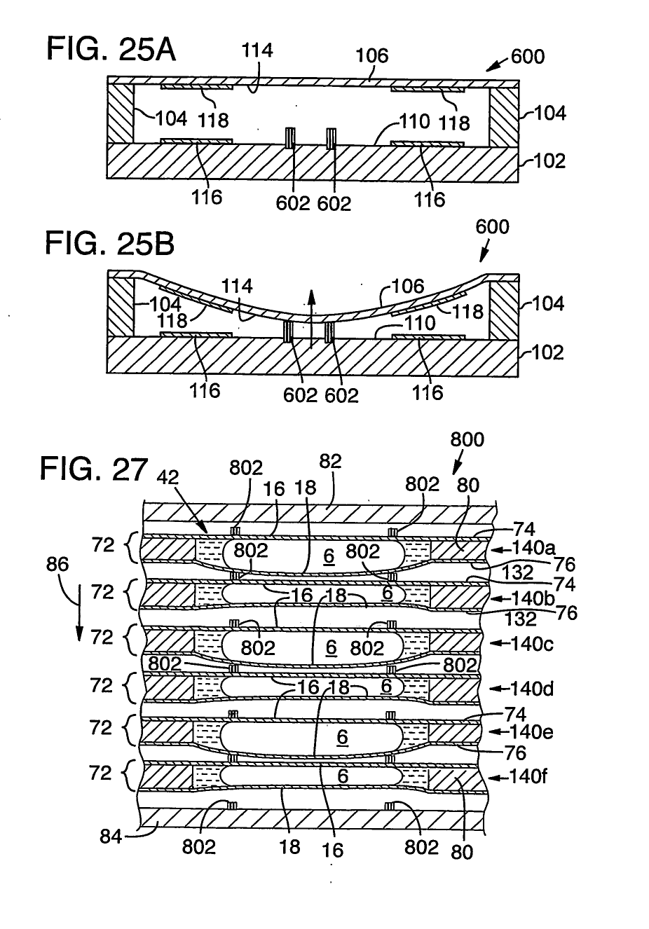

FIGS. 25A and 25B show a thermal switch 600 employing a nanostructure, according to one embodiment. The thermal switch 600 is similar in construction to the thermal switch 100 shown in FIGS. 10A and 10B. Thus, components in FIGS. 25A and 25B that are identical to respective components in FIGS. 10A and 10B have the same respective reference numerals and are not described further. The difference between the thermal switch 600 of FIGS. 25A and 25B and the thermal switch 100 of FIGS. 10A and 10B is that the former includes one or more nanostructures 602 instead of the drops 108 and the contacts 112.

The nanostructures 602 can be bundles of aligned carbon nanotubes and can include a matrix material, although other types of nanostructures also can be used. The nanostructures 602 can be supported in respective recesses in the upper surface of the thermally conductive member 102 as shown or supported directly on the upper surface of the thermally conductive member 102 or on respective contacts on the upper surface of the thermally conductive member 102. As shown, the nanostructures 602 desirably are oriented such that the individual nanotubes extend lengthwise between the first thermally conductive member 102 and the second thermally conductive member 106 to maximize heat transfer between the thermally conductive members through the nanostructures.

The thermal switch 600 operates in the same manner as the thermal switch 100 of FIGS. 10A and 10B. Thus, the second thermally conductive member 106 is selectively deflectable between a non-deflected position spaced from the nanostructures 602 (FIG. 25A) and a non-deflected position contacting the nanostructures (FIG. 25B) to alternately establish a path of high thermal resistance and a path of low thermal resistance, respectively, between the first thermally conductive member 102 and the second thermally conductive member 106.

The nanostructures 602 can be formed using any of various known techniques. In particular embodiments, for example, nanotubes are synthesized in defined locations via direct patterning and/or deposition of catalytic materials, such as described in International Patent Application Publication No. WO 2004/012932 to Jiao et al. (“Jiao”), which is incorporated herein by reference. In one specific approach described in Jiao, “pillars” are formed at defined locations on a substrate using a suitable technique, such as photolithography, electron beam (EB) induced deposition, or deposition induced by a focused ion beam (FIB). The pillars can be any of various metals, such as Al, Au, Fe, Ni, Co, Pt, or W, and various combinations thereof. The substrate can be any solid material, such as silicon, silicon nitride, glass, ceramic, plastic, oxide, semiconductor material, quartz, mica, or metal, or a combination thereof.

Catalytic material is then selectively deposited by FIB- or EB-induced deposition or other suitable technique on the pillars to define catalytic sites for synthesizing nanotubes. Alternatively, a layer of a catalyst can be deposited on the substrate over the pillars, using a suitable technique such as sputter-coating or spin-coating. The catalyst layer can then be patterned to define the catalytic sites on top of the pillars. Any suitable technique capable of patterning the catalytic sites can be used, such as thermal decomposition, FIB milling, or other micro-machining technique. Any of various catalysts known in the art can be used. Typically, catalysts include a metal, such as Fe, Co, Ni, Ti, Cu, Mg, Y, Zn, any of various alloys thereof, and any of various combinations thereof.

After the catalytic sites are formed, bundles of carbon nanotubes are synthesized on the catalytic sites using known techniques, such chemical vapor deposition (CVD). For example, U.S. Pat. No. 6,346,189 to Dai et al., which is incorporated herein by reference, discloses a CVD process suitable for the synthesis of predominantly single-walled nanotubes. Other processes also can be used, such as those disclosed in U.S. Pat. No. 5,500,200 to Mandeville, which is incorporated herein by reference. The processes disclosed in the '200 patent to Mandeville tend to yield predominantly multi-walled nanotubes. Each nanostructure is defined by a pillar, a catalytic layer, and multiple nanotubes extending from the catalytic layer. The foregoing process tends to produce nanotubes that are substantially aligned with each other, and therefore exhibit good thermal conductance.

In alternative embodiments, the catalytic sites can be formed directly on a substrate rather than on pillars. Also, any of various other known processes can be used to synthesize bundles of nanotubes or other nanostructures, such as described in Terrones, the '189 patent to Dai, and the '200 patent to Mandeville.

In particular embodiments, each nanostructure 602 can be a nanocomposite comprising individual nanotubes within a matrix material. The matrix material can be, for example, a polymer (e.g., PMMA, polystyrene, polyaniline, polycarbonate, or acetal), a ceramic, a metal, or a combination thereof. The matrix material can be applied to the nanotubes using known techniques. In certain embodiments, a capping layer is applied over the nanocomposite structures to secure the ends of the individual nanotubes, and the matrix material is removed via, for example, chemical dissolution. The capping layer can be made of the same material as the matrix material or a different material. For example, the matrix material can be a polymer and the capping layer can be a metal (e.g., Au, Ni, or other suitable metal), which can be applied using a known technique (e.g., sputtering or electroplating).

In certain embodiments, the substrate on which the nanostructures are formed is the thermally conductive layer 102 of the thermal switch. In other embodiments, the nanostructures are separated from each other and are subsequently deposited on a separate substrate forming the thermally conductive layer 102. In one approach, for example, the individual nanostructures are placed in an aqueous suspension. The layer 102 is then flooded with the aqueous suspension of nanostructures and agitated to cause the nanostructures to preferentially lodge in the recesses formed on the upper surface of the layer 102.

A method for fabricating the thermal switch 600, according to a specific example, includes synthesizing bundles of carbon at defined locations on a substrate, embedding the nanotubes within a matrix of PMMA to form a plurality of nanocomposite structures, and forming a capping layer of PMMA over the structures. The substrate is then separated into 300×100×10 micron nanostructures. The thermally conductive layer 102 is formed from a silicon wafer, which is selectively etched at defined locations to a depth of about 3-5 microns to form the recesses for receiving the nanostructures. The thermally conductive layer 102 is then flooded with an aqueous suspension of the nanostructures and agitated to cause the nanostructures to settle in the recesses. A 8-10 micron layer of PMMA is applied on the thermally conductive layer 102 and selectively etched to form the spacers 104. The second thermally conductive layer 106 is formed from a silicon wafer, which is positioned over the spacers 104 and secured in place.

In another embodiment, a thermal switch can have a configuration similar to that shown in FIGS. 11A and 11B, except that the liquid drops 108 and the contacts 112 are replaced with nanostructures 602.

FIGS. 26A and 26B show an embodiment of a thermal-switch assembly 700 comprising a 3×3 array of independently operable thermal switches 702. The thermal-switch assembly 700 is similar in construction to and operates in the same manner as the thermal-switch assembly 150 shown in FIGS. 13A and 13B. Thus, components in FIGS. 26A and 26B that are identical to respective components in FIGS. 13A and 13B have the same respective reference numerals and are not described further. The difference between the thermal-switch assembly 700 of FIGS. 26A and 26B and the thermal-switch assembly 150 of FIGS. 13A and 13B is that the former includes one or more nanostructures 704 instead of the drops 108 and the contacts 112.

As shown, the nanostructures 704 can be positioned in respective recesses formed in the inner surface of the second substrate 156. During use, each membrane 160 functions as an actuator that is selectively deflectable between a non-deflected position (shown in FIG. 26B) and a deflected position (not shown in the drawings) to thermally contact (e.g., physically contact) a respective nanostructure 704. Although the illustrated embodiment comprises a 3×3 array of thermal switches, it will be appreciated that the assembly can be modified as desired to include any number of thermal switches.

FIG. 27 illustrates an energy-conversion apparatus, indicated generally at 800, that is similar to the apparatus 130 shown in FIG. 12, except that the liquid droplets 132 in the FIG. 12 apparatus are replaced with nanostructures 802 to define thermal switches between adjacent levels of micro-heat engines 42. The apparatus 800 can be operated in the same manner as the apparatus 130 of FIG. 12 or the apparatus 70 of FIG. 5. During use, the nanostructures 802 control the flow of heat into and away from each heat engine 42 by facilitating the transfer of heat into a heat engine during a heat-addition process and by facilitating the transfer of heat out of a heat engine during a heat-rejection process. The nanostructures 802 can be fabricated according to any of the techniques described herein.

Thermal switches employing nanostructures can also be implemented in other types of devices. For example, the thermal-switch assembly 700 of FIGS. 26A and 26B can be used in the thermoelectric cooler 200 shown in FIG. 14 in lieu of the thermal-switch assembly 150. As another example, the thermal-switch assemblies 150, 150′ in the thermal cycler 300 of FIG. 15 can be replaced with thermal-switch assemblies 700.

In other embodiments, a thermal switch (e.g., the thermal switch 600 of FIGS. 25A and 25B) or a thermal-switch assembly 700 (e.g., the thermal-switch assembly 700 of FIGS. 26A and 26B) can include one or more bundles of carbon fibers in lieu of one or more nanostructures to conduct heat between two heat transfer surfaces. Carbon fibers also can be implemented in the energy-conversion apparatus shown in FIG. 27 to transfer heat between adjacent levels of heat engines 42.

The present invention has been shown in the described embodiments for illustrative purposes only. The present invention may be subject to many modifications and changes without departing from the spirit or essential characteristics thereof We therefore claim as our invention all such modifications as come within the spirit and scope of the following claims.

We claim:

1. A thermal switch for controlling the flow of heat between a heat source and a heat sink, the thermal switch comprising at least one nanostructure, wherein the thermal switch is configured to alternately form a path of high thermal conductance between the heat source and the heat sink via the at least one nanostructure, and a path of low thermal conductance between the heat source and the heat sink.

2. The thermal switch of claim 1, further comprising an actuator configured to alternately move between a first position to form the path of high thermal conductance and a second position to form the path of low thermal conductance.

3. The thermal switch of claim 2, wherein the actuator is deflectable to alternately deflect between the first position in which the actuator contacts the at least one nanostructure to form the path of high thermal conductance and the second position in which the actuator is spaced from the at least one nanostructure to form the path of low thermal conductance.

4. The thermal switch of claim 3, wherein the actuator comprises an electrostatic transducer that deflects to the first position upon application of a voltage to the transducer.

5. The thermal switch of claim 3, wherein the actuator comprises a piezoelectric transducer that deflects to the first position upon application of a voltage to the transducer.

6. The thermal switch of claim 1, wherein the at least one nanostructure comprises a bundle of carbon nanotubes.

7. The thermal switch of claim 6, wherein the at least one nanostructure further comprises a matrix material between the carbon nanotubes.

8. The thermal switch of claim 1, further comprising a fluid-tight cavity interposed between the heat sink and the heat source, the at least one nanostructure being disposed in the cavity, and the cavity containing an insulating gas to increase the thermal resistance of the switch whenever the switch is activated to establish the path of low thermal conductance.

9. The thermal switch of claim 1, further comprising a fluid-tight cavity interposed between the heat sink and the heat source, the at least one nanostructure being disposed in the cavity, and the cavity being evacuated to increase the thermal resistance of the switch whenever the switch is activated to establish the path of low thermal conductance.

10. A thermal switch for controlling the flow of heat into or away from a body, comprising:
at least one nanostructure; and
an activation element that is selectively movable between a first position to activate the thermal switch and allow heat to flow into or away from the body through the nanostructure, and a second position to de-activate the thermal switch to reduce the flow of heat into or away from the body.

11. The thermal switch of claim 10, wherein the at least one nanostructure comprises a bundle of carbon nanotubes.

12. The thermal switch of claim 11, wherein the at least one nanostructure further comprises a matrix material between the carbon nanotubes.

13. A thermal-switch assembly, comprising:
a first major layer;
a second major layer; and
a plurality of thermal-switch elements cooperatively formed between the first and second major layers, each thermal switch element defining a heat-transfer path and being selectively and independently operable relative to each other to alternately increase and decrease the transfer of heat between the first and second major layers via the respective heat-transfer path.

14. The thermal-switch assembly of claim 13, wherein the thermal-switch elements comprise an array of thermal-switch elements formed by the first and second major layers.

15. The thermal-switch assembly of claim 13, wherein each thermal-switch element comprises a drop of a thermally conductive liquid disposed between the first and second major layers.

16. The thermal-switch assembly of claim 15, wherein each thermal-switch element comprises a flexible membrane formed in the first major layer that is selectively deflectable between a deflected position in which the membrane contacts a respective drop and a non-deflected position in which the membrane is spaced from the respective drop.

17. The thermal-switch assembly of claim 16, wherein:
each thermal-switch element comprises at least one first electrode mounted on a respective flexible membrane and at least one second electrode mounted on the second major layer; and
whenever a voltage is applied to the first and second electrodes of one of the thermal-switch elements, the respective flexible membrane is caused to deflect and contact a respective drop.

18. The thermal-switch assembly of claim 13, wherein each thermal-switch element comprises at least one nanostructure disposed between the first and second major layers.

19. The thermal-switch assembly of claim 18, wherein each thermal-switch element comprises a flexible membrane formed in the first major layer that is selectively deflectable between a deflected position in which the membrane contacts a respective nanostructure and a non-deflected position in which the membrane is spaced from the respective nanostructure.

20. The thermal-switch assembly of claim 19, wherein each thermal-switch element comprises at least one first electrode mounted on a respective flexible membrane and at least one second electrode mounted on the second major layer; and
whenever a voltage is applied to the first and second electrodes of one of the thermal-switch elements, the respective flexible membrane is caused to deflect and contact a respective nanostructure.

21. An energy-converting apparatus, comprising:
a first micro-transducer operable to convert energy in one form to energy in another form;
a second micro-transducer operable to convert energy in one form to energy in another form; and
at least one nanostructure disposed between the first and second micro-transducers and adapted to alternately establish a path of high thermal conductance between the first and second micro-transducers to facilitate the flow of heat therebetween and a path of low thermal conductance between the first and second micro-transducers to inhibit the flow of heat therebetween.

22. The apparatus of claim 21, wherein:
the first and second micro-transducers comprise first and second micro-heat engines, respectively, and each micro-heat engine being operable to convert thermal energy into electrical energy; and
heat from the first micro-heat engine is transferred to the second micro-heat engine whenever the path of high thermal conductance is established by the at least one carbon nanostructure.

23. The apparatus of claim 22, further comprising a load operatively connected to the first and second micro-heat engines, wherein the load consumes electrical energy generated by the micro-heat engines.

24. The apparatus of claim 21, wherein:
the first and second micro-transducers comprise first and second micro-heat pumps, respectively; and
heat rejected by the first micro-heat pump is transferred to the second micro-heat pump whenever the path of high thermal conductance is established by the at least one nanostructure.

25. The apparatus of claim 21, wherein:
the at least one nanostructure is in constant thermal contact with the first micro-transducer;
the second micro-transducer comprises a flexible membrane that is alternately deflectable between a deflected position and a non-deflected position; and
whenever the flexible member is in the deflected position, the flexible member contacts the at least one nanostructure to establish the path of high thermal conductance, and wherein whenever the flexible member is in the non-deflected position, the flexible member is spaced from the at least one nanostructure to establish the path of low thermal conductance.

26. A method for transferring heat from a heat source to a heat sink, the method comprising alternately establishing a low-thermal-resistance path between the heat source and the heat sink to allow heat to be conducted between the heat source and the heat sink through a nanostructure, and a high-thermal-resistance path between the heat source and the heat sink to inhibit the conduction of heat between the heat source and the heat sink.

27. The method of claim 26, wherein:
establishing the low-thermal-resistance path comprises contacting the nanostructure with the heat source and the heat sink; and
establishing the high-thermal-resistance path comprises creating a gap between the nanostructure and at least one of the heat source and the heat sink.

28. The method of claim 26, wherein:
the heat source comprises a low-temperature heat source of a thermoelectric cooler and the heat sink comprises a high-temperature heat sink of a thermoelectric cooler; and
the method further comprises selectively thermally coupling the low-temperature heat source to the thermoelectric cooler via the nanostructure to allow the thermoelectric cooler to absorb heat from the low-temperature heat source and pass heat to the high-temperature heat sink.

29. The method of claim 26, wherein:
the heat source is a first micro-transducer and the heat sink is a second micro-transducer; and
the method comprises intermittingly thermally coupling the first micro-transducer to the second micro-transducer to allow heat to be transferred from the first micro-transducer to the second micro-transducer through the nanostructure.

30. A micro-transducer, comprising:
a fluid-tight cavity;
a working fluid contained in the cavity;
a deflectable membrane bounding at least a portion of the cavity; and
a wick structure disposed on an inner surface of the cavity and configured to hold at least a portion of the working fluid.

31. The micro-transducer of claim 30, wherein the wick structure comprises a plurality of radially spaced, concentric wicks.

32. The micro-transducer of claim 30, wherein the wick structure comprises a plurality of radially extending, angularly spaced-wicks.

33. The micro-transducer of claim 30, wherein the wick structure is made of photoresist.

34. The micro-transducer of claim 30, wherein the deflectable membrane comprises a piezoelectric membrane that is operable as an actuator to compress the working fluid whenever an electric field is applied to the piezoelectric membrane and operable as a generator to generate an electric charge whenever the working fluid expands.

35. The micro-transducer of claim 30, wherein the working fluid is a saturated mixture of vapor and liquid.

36. The micro-transducer of claim 30, further comprising:
a first thermal switch configured to intermittently thermally couple the micro-transducer to a heat source to allow heat to flow from the heat source into the micro-transducer; and
a second thermal switch configured to intermittently thermally couple the micro-transducer to a heat sink to allow heat to flow from the micro-transducer to the heat sink.

37. The micro-transducer of claim 36, wherein:
the first thermal switch comprises a first nanostructure oriented such that heat flows through the first nanostructure whenever the micro-transducer is thermally coupled to the heat source; and
the second thermal switch comprises a second nanostructure oriented such that heat flows through the second nanostructure whenever the micro-transducer is thermally coupled to the heat sink.

38. The micro-transducer of claim 36, wherein:
the first thermal switch comprises a first drop of a thermally conductive liquid positioned such that heat flows through the first drop whenever the micro-transducer is thermally coupled to the heat source; and
the second thermal switch comprises a second drop of a thermally conductive liquid positioned such that heat flows through the second drop whenever the micro-transducer is thermally coupled to the heat sink.

39. A thermal switch for controlling the flow of heat between a heat source and a heat sink, the thermal switch comprising at least one drop of a thermally conductive liquid, wherein the thermal switch is configured to alternately form a path of high thermal conductance between the heat source and the heat sink via the at least one drop, and a path of low thermal conductance between the heat source and the heat sink.

40. The thermal switch of claim 39, further comprising an actuator configured to alternately move between a first position to form the path of high thermal conductance and a second position to form the path of low thermal conductance.

41. The thermal switch of claim 40, wherein the actuator is deflectable to alternately deflect between the first position in which the actuator contacts the at least one drop to form the path of high thermal conductance and the second position in which the actuator is spaced from the at least one drop to form the path of low thermal conductance.

42. The thermal switch of claim 41, wherein the actuator comprises an electrostatic transducer that deflects to the first position upon application of a voltage to the transducer.

43. The thermal switch of claim 41, wherein the actuator comprises a piezoelectric transducer that deflects to the first position upon application of a voltage to the transducer.

44. The thermal switch of claim 39, wherein the drop is about 10 microns to about 1000 microns in diameter.

45. The thermal switch of claim 39, wherein the drop comprises mercury.

46. The thermal switch of claim 39, further comprising a fluid-tight cavity interposed between the heat sink and the heat source, and wherein the at least one drop is disposed in the cavity, the cavity containing an insulating gas to increase the thermal resistance of the switch whenever the switch is activated to establish the path of low thermal conductance.

47. The thermal switch of claim 39, further comprising a fluid-tight cavity interposed between the heat sink and the heat source, and wherein the at least one drop is disposed in the cavity, and a vacuum is established in the cavity to increase the thermal resistance of the switch whenever the switch is activated to establish the path of low thermal conductance.

48. A thermal switch for controlling the flow of heat into or away from a body, comprising:
a drop of a thermally conductive liquid; and
an activation element that is selectively movable between a first position to activate the thermal switch and allow heat to flow into or away from the body through the drop, and a second position to de-activate the thermal switch to reduce the flow of heat into or away from the body through the drop.

49. The thermal switch of claim 48, wherein the liquid is a metal.

50. The thermal switch of claim 48, wherein the drop is disposed on a metal contact.

51. A method for transferring heat from a heat source to a heat sink, the method comprising alternately establishing a low-thermal-resistance path between the heat source and the heat sink to allow conduction of heat between the heat source and the heat sink through a drop of a thermally conductive liquid, and a high-thermal-resistance path between the heat source and the heat sink to inhibit the conduction of heat between the heat source and the heat sink.

52. The method of claim 51, wherein:
establishing the low-thermal-resistance path comprises contacting the drop with the heat source and the heat sink; and
establishing the high-thermal-resistance path comprises creating a gap between the drop and at least one of the heat source and the heat sink.

53. The method of claim 51, wherein:
the heat source comprises a low-temperature heat source of a thermoelectric cooler and the heat sink comprises a high-temperature heat sink of the thermoelectric cooler; and
the method further comprises selectively thermally coupling the low-temperature heat source to the thermoelectric cooler via the drop to allow the thermoelectric cooler to absorb heat from the low-temperature heat source and pass heat to the high-temperature heat sink.

54. The method of claim 51, wherein:
the heat source is a first micro-transducer and the heat sink is a second micro-transducer; and
the method comprises intermittingly thermally coupling the first micro-transducer to the second micro-transducer to allow heat to be transferred from the first micro-transducer to the second micro-transducer through the drop.

55. A thermal cycler, comprising:
a tube-support device that supports one or more containers each configured to contain a sample to be processed by the thermal cycler;
a heat source configured to supply heat to the samples in the containers;
a cold source configured to supply cold to the samples in the containers; and
at least one thermal switch configured to selectively thermally couple the heat source or the cold source to the containers.

56. The thermal cycler of claim 55, wherein the thermal switch comprises at least one nanostructure configured such that heat flows through the nanostructure whenever the thermal switch thermally couples the containers to the heat source or the cold source.

57. The thermal cycler of claim 55, wherein the thermal switch comprises at least one drop of a thermally conductive liquid situated such that heat flows through the drop whenever the thermal switch thermally couples the containers to the heat source or the cold source.

58. The thermal cycler of claim 55, wherein the at least one thermal switch comprises a first thermal switch and a second thermal switch, the first thermal switch being configured to selectively thermally couple the heat source to the containers, and the second thermal switch being configured to selectively thermally couple the cold source to the containers.

59. A thermoelectric cooler, comprising:
a low-temperature heat source;
a high-temperature heat sink;
a thermoelectric element thermally coupled to the high-temperature heat sink; and
a thermal switch comprising at least nanostructure, the thermal switch being configured to couple the low-temperature heat source to the thermoelectric element and to allow heat to flow from the heat source to the thermoelectric element via the nanostructure.

60. A thermoelectric cooler, comprising:
a low-temperature heat source,
a high-temperature heat sink;
a thermoelectric element-thermally-coupled to the high-temperature heat sink; and
a thermal switch comprising at least one drop of a thermally conductive liquid, the thermal switch being configured to couple the low-temperature heat source to the thermoelectric element and allow heat to flow from the heat source to the thermoelectric element via the drop.

61. A thermal switch, comprising:
a body defining a fluid-tight cavity having first and second major surfaces;
a working fluid contained in the cavity, wherein the cavity is operable as a heat pipe to cause the working fluid to transfer latent heat from the first major surface to the second major surface;
a flexible membrane forming the first major surface of the cavity, the membrane being deflectable inwardly toward the second major surface of the cavity; and
at least one wick formed on the membrane and positioned to absorb working fluid that has condensed on the second major surface whenever the membrane is deflected inwardly toward the second major surface.
